(19) United States
(12) Patent Application Publication
(10) Pub. No.: US 2012/0019570 A1
(43) Pub. Date: Jan. 26, 2012

(54) METHOD FOR DRIVNG PLASMA DISPLAY PANEL AND PLASMA DISPLAY DEVICE

(75) Inventors: Yutaka Yoshihama, Osaka (JP); Tomomitsu Masuda, Osaka (JP)

(73) Assignee: Panasonic Corporation, Osaka (JP)

(21) Appl. No.: 13/255,114

(22) PCT Filed: Apr. 2, 2010
(86) PCT No.: PCT/JP2010/002438

§ 371 Date: Sep. 7, 2011

(30) Foreign Application Priority Data
Apr. 13, 2009 (JP) 2009-096826

(51) Int. Cl. G09G 3/28; G09G 5/10

(52) U.S. Cl. 345/690; 345/63

(57) ABSTRACT

In the display of an image at a low average picture level, the luminance of black level of the display image is reduced so as to enhance the contrast. In the display of an image at a high average picture level, an address discharge is caused stably. Thereby, the image display quality is enhanced. For this purpose, a specified-cell initializing subfield where a forced initializing waveform is applied to predetermined scan electrodes and a non-initializing waveform is applied to the other scan electrodes in the initializing period, and a selective initializing subfield where a selective initializing waveform is applied to all the scan electrodes in the initializing period are set. A specified-cell initializing field having the specified-cell initializing subfield and the plurality of selective initializing subfields is set. The frequency of forced initializing waveforms generated is changed according to the magnitude of average picture level of an input image signal such that the frequency of forced initializing waveforms applied to the scan electrodes is reduced as the average picture level decreases.

THIS APPLICATION IS A U.S. NATIONAL PHASE APPLICATION OF PCT INTERNATIONAL APPLICATION NO. PCT/JP2010/002438.

### TECHNICAL FIELD

The present invention relates to a driving method for a plasma display panel, and a plasma display device that are used in a wall-mounted television or a large monitor.

### BACKGROUND ART

A typical alternating-current surface discharge panel used as a plasma display panel (hereinafter, simply referred to as “panel”) has a large number of discharge cells that are formed between a front plate and a rear plate facing each other. The front plate has the following elements:
a plurality of display electrode pairs, each formed of a scan electrode and a sustain electrode, disposed on a front glass substrate parallel to each other; and
a dielectric layer and a protective layer formed so as to cover the display electrode pairs. The rear plate has the following elements:
a plurality of parallel data electrodes formed on a rear glass substrate;
a dielectric layer formed so as to cover the data electrodes;
a plurality of barrier ribs formed on the dielectric layer parallel to the data electrodes; and
phosphor layers formed on the surface of the dielectric layer and on the side faces of the barrier ribs.

The front plate and the rear plate face each other such that the display electrode pairs and the data electrodes three-dimensionally intersect, and are sealed together. A discharge gas containing xenon in a partial pressure ratio of 5%, for example, is sealed into the inside discharge space. Discharge cells are formed in portions where the display electrode pairs face the data electrodes. In a panel having such a structure, gas discharge generates ultraviolet light in each discharge cell. This ultraviolet light excites the red (R), green (G), and blue (G) phosphors so that the phosphors emit the respective colors for color display.

As a driving method for the panel, a subfield method is typically used. In the subfield method, one field is divided into a plurality of subfields, and light emission and no light emission in the respective discharge cells are controlled in the respective subfields. Then, the number of light emissions caused in one field is controlled for gradation display.

Each subfield has an initializing period, an address period, and a sustain period. In the initializing period, an initializing waveform is applied to the respective scan electrodes so as to cause an initializing discharge in the respective discharge cells. This initializing discharge forms wall charge necessary for the subsequent address operation in the respective discharge cells and generates priming particles (excitation particles for causing an address discharge) for causing the address discharge stably.

In the address period, a scan pulse is sequentially applied to the scan electrodes, and an address pulse corresponding to a signal of an image to be displayed is selectively applied to the data electrodes. Thereby, an address discharge is caused between the scan electrodes and the data electrodes so as to form wall charge in the discharge cells to be lit (hereinafter, this operation being referred to as “addressing”).

In the sustain period, a sustain pulse is alternately applied to display electrode pairs, each formed of a scan electrode and a sustain electrode, at a number of times predetermined for each subfield. Thereby, a sustain discharge is caused in the discharge cells where the address discharge has formed wall charge, and thus causes the phosphor layers in the discharge cells to emit light. In this manner, an image is displayed in the image display area of the panel.

One of important factors in enhancing image display quality in a panel is to enhance contrast. As one of the subfield methods, a driving method for minimizing the light emission unrelated to gradation display so as to enhance the contrast ratio is disclosed.

In this driving method, the following operations are performed. In the initializing period of one subfield among a plurality of subfields forming one field, an initializing operation for causing an initializing discharge in all the discharge cells is performed. In the initializing periods of the other subfields, an initializing operation for causing an initializing discharge selectively in the discharge cells having undergone a sustain discharge in the immediately preceding sustain period is performed.

Luminance in an area displaying a black picture (hereinafter, simply referred to as “luminance of black level”) where no sustain discharge is caused is changed by the light emission unrelated to image display. Examples of such light emission include a light emission caused by the initializing discharge. In the above driving method, the light emission in the area displaying a black picture is only a weak light emission caused when an initializing operation is performed in all the discharge cells. This method can reduce the luminance of black level and thus allows the display of an image having a high contrast (see Patent Literature 1, for example).

Further, a technique for reducing luminance of black level so as to enhance visibility of black display is disclosed (see Patent Literature 2, for example). In this technique, an initializing period where an initializing waveform is applied to the discharge cells having undergone a discharge in the sustain period is set. This initializing waveform has a rising part including a gentle ramp portion where voltage gradually rises, and a falling part including a gentle ramp portion where the voltage gradually falls. Immediately before any one of the initializing periods in one field, a period where a weak discharge is caused between the sustain electrodes and the scan electrodes in all the discharge cells is set.

In the technique disclosed in Patent Literature 1, the initializing operation for causing an initializing discharge in all the discharge cells is performed once in a field. This structure can reduce the luminance of black level of the display image and thus enhance the contrast, compared with the case where an initializing discharge is caused in all the discharge cells in each subfield.

However, with a recent increase in the screen size and definition of a panel, it is requested to further enhance the image display quality.

### CITATION LIST

### Patent Literature

### [PTL1]

Japanese Patent Unexamined Publication No. 2000-242224

### [PTL2]

Japanese Patent Unexamined Publication No. 2004-37883

### SUMMARY OF THE INVENTION

In a driving method for a panel,
the panel having a plurality of discharge cells, the discharge cells having display electrode pairs, each of the display electrode pairs being formed of a scan electrode and a sustain electrode,
the panel displaying gradations such that a plurality of subfields is set in one field and each of the subfields has an initializing period, an address period, and a sustain period,
the driving method includes:
applying one of a forced initializing waveform, a selective initializing waveform, and a non-initializing waveform to the scan electrodes in the initializing period, the forced initializing waveform causing an initializing discharge in the discharge cells irrespective of the operation in the immediately preceding subfield, the selective initializing waveform causing an initializing discharge only in the discharge cells having undergone a sustain discharge in the sustain period of the immediately preceding subfield, the non-initializing waveform causing no initializing discharge in the discharge cells;
setting a specified-cell initializing subfield and a selective initializing subfield, the specified-cell initializing subfield being where the forced initializing waveform is applied to predetermined scan electrodes and the non-initializing waveform is applied to the other scan electrodes in the initializing period, and the selective initializing subfield being where the selective initializing waveform is applied to all the scan electrodes in the initializing period;
setting a specified-cell initializing field having the specified-cell initializing subfield and the plurality of selective initializing subfields; and
changing the frequency of the forced initializing waveforms to be generated, according to the magnitude of an average picture level of an input image signal, such that the frequency of the forced initializing waveforms to be applied to the scan electrodes is reduced as the average picture level decreases.

This operation can control the frequency of initializing discharges caused by the forced initializing waveforms, i.e. one of major factors in increasing luminance of black level, according to the average picture level of the input image signal. Therefore, in the display of an image at a low average picture level where dark areas are relatively large on the image display surface of the panel, the frequency of initializing discharges caused by the forced initializing waveforms is reduced so as to reduce the luminance of black level of the display image and enhance the contrast. In the display of an image at a high average picture level where a relatively large number of address discharges tend to occur unstably, the frequency of initializing discharges caused by the forced initializing waveforms is increased so as to cause the address discharge stably. Thereby, this operation can enhance image display quality in a plasma display device.

### BRIEF DESCRIPTION OF DRAWINGS

FIG. 1 is an exploded perspective view showing a structure of a panel in accordance with a first exemplary embodiment of the present invention.

FIG. 2 is an electrode array diagram of the panel.

FIG. 3 is a waveform chart of driving voltages applied to the respective electrodes of the panel.

FIG. 4 is a circuit block diagram of a plasma display device in accordance with the first exemplary embodiment of the present invention.

FIG. 5 is a circuit diagram showing a configuration example of a scan electrode driving circuit of the plasma display device.

FIG. 6 is a timing chart for explaining an example of the operation of the scan electrode driving circuit in the initializing period of a specified-cell initializing subfield in accordance with the first exemplary embodiment of the present invention.

FIG. 7 is a chart showing an example of numerical value ranges of average picture level (APL) and frequencies of forced initializing waveforms set for the respective numerical value ranges in accordance with the first exemplary embodiment.

FIG. 8 is a schematic chart showing an example of the pattern of forced initializing waveforms and non-initializing waveforms generated when the frequency of forced initializing operations performed in each discharge cell is once every six fields in accordance with the first exemplary embodiment.

FIG. 9 is a schematic chart showing an example of the pattern of forced initializing waveforms and non-initializing waveforms generated when the frequency is once every four fields.

FIG. 10 is a schematic chart showing an example of the pattern of forced initializing waveforms and non-initializing waveforms generated when the frequency is once every three fields.

FIG. 11 is a schematic chart showing an example of the pattern of forced initializing waveforms and non-initializing waveforms generated when the frequency is once every two fields.

FIG. 12 is a schematic chart showing an example of the pattern of forced initializing waveforms and non-initializing waveforms generated when the frequency is three times every four fields.

FIG. 13 is a chart showing changes in luminance of black level (relative values) when the frequency of forced initializing operations performed in each discharge cell is changed.

FIG. 14 is a schematic chart showing an example of the operation when the intervals at which forced initializing waveforms are generated are changed in a second exemplary embodiment of the present invention.

FIG. 15 is a chart showing an example of cumulative values of the operating time of a plasma display device and frequencies of forced initializing waveforms generated in accordance with a third exemplary embodiment of the present invention.

### DETAILED DESCRIPTION OF PREFERRED EMBODIMENTS

Hereinafter, a plasma display device in accordance with exemplary embodiments of the present invention will be described, with reference to the accompanying drawings.

### First Exemplary Embodiment

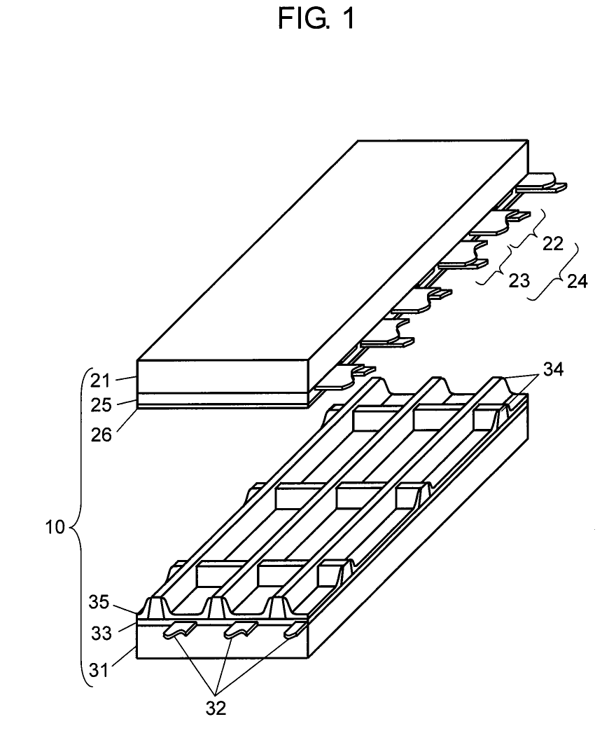

FIG. 1 is an exploded perspective view showing a structure of panel 10 in accordance with the first exemplary embodiment of the present invention. A plurality of display electrode pairs 24, each formed of scan electrode 22 and sustain electrode 23, is disposed on glass front plate 21. Dielectric layer 25 is formed so as to cover scan electrodes 22 and sustain electrodes 23. Protective layer 26 is formed over dielectric layer 25. Protective layer 26 is made of a material predominantly composed of magnesium oxide (MgO).

A plurality of data electrodes 32 is formed on rear plate 31. Dielectric layer 33 is formed so as to cover data electrodes 32, and mesh barrier ribs 34 are formed on the dielectric layer. On the side faces of barrier ribs 34 and on dielectric layer 33, phosphor layers 35 for emitting light in red (R), green (G), and blue (B) colors are formed.

Front plate 21 and rear plate 31 face each other such that display electrode pairs 24 intersect with data electrodes 32 with a small discharge space sandwiched between the electrodes. The outer peripheries of the plates are sealed with a sealing material, e.g. a glass frit. In the inside discharge space, a mixed gas of neon and xenon is sealed as a discharge gas. In this exemplary embodiment, a discharge gas having a xenon partial pressure of approximately 10% is used to improve the emission efficiency. The discharge space is partitioned into a plurality of compartments by barrier ribs 34. Discharge cells are formed in the intersecting parts of display electrode pairs 24 and data electrodes 32. The discharge cells discharge and emit light so as to display an image.

The structure of panel 10 is not limited to the above, and may include barrier ribs formed in a stripe pattern. The mixing ratio of the discharge gas is not limited to the above numerical value, and other mixing ratios may be used.

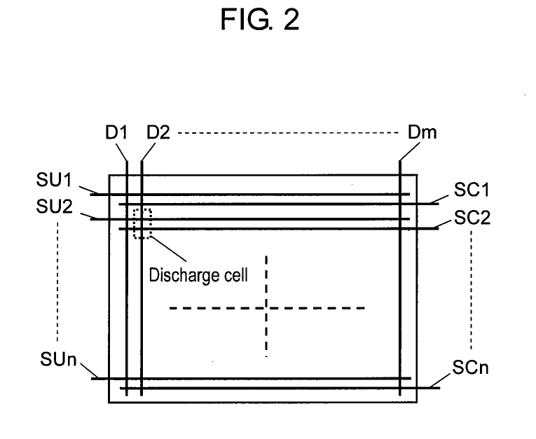

FIG. 2 is an electrode array diagram of panel 10 in accordance with the first exemplary embodiment of the present invention. Panel 10 has n scan electrode SC1 through scan electrode SCn (scan electrodes 22 in FIG. 1) and n sustain electrode SU1 through sustain electrode SUn (sustain electrodes 23 in FIG. 1) both long in the row direction, and m data electrode D1 through data electrode Dm (data electrodes 32 in FIG. 1) long in the column direction. A discharge cell is formed in the part where a pair of scan electrode SCi (i being 1 through n) and sustain electrode SUi intersects with one data electrode Dk (k being 1 through m). Thus, m×n discharge cells are formed in the discharge space. The area where m×n discharge cells are formed is the display area of panel 10.

Next, driving voltage waveforms for driving panel 10 and the operation thereof are outlined. A plasma display device of this exemplary embodiment displays gradations by a subfield method. That is, one field is divided into a plurality of subfields along a temporal axis, a luminance weight is set for each subfield, and light emission or no light emission in each discharge cell is controlled in each subfield for gradation display on panel 10.

In this subfield (SF) method, one field is formed of eight subfields (the first SF, and the second SF through the eighth SF), and the respective subfields have luminance weights of 1, 2, 4, 8, 16, 32, 64, and 128, for example. In the sustain period of each subfield, sustain pulses equal in number to the luminance weight of the subfield multiplied by a predetermined luminance magnification are applied to respective display electrode pairs 24.

In the initializing period of one subfield among the plurality of subfields, an initializing operation for performing a “forced initializing operation” and a “non-initializing operation” selectively (hereinafter, such an initializing operation being referred to as “specified-cell initializing operation”) is performed. In the initializing periods of the other subfields, a “selective initializing operation” is performed. These operations can minimize the light emission unrelated to gradation display and enhance the contrast ratio. The “forced initializing operation” is an initializing operation for causing an initializing discharge in the discharge cells irrespective of the operation in the immediately preceding subfield. The “non-initializing operation” is an operation for causing no initializing discharge by-up-ramp voltage in the discharge cells in the initializing period. The up-ramp voltage will be described later. The “selective initializing operation” is an initializing operation for causing an initializing discharge only in the discharge cells having undergone a sustain discharge in the sustain period of the immediately preceding subfield. Hereinafter, a subfield where the specified-cell initializing operation is performed in the initializing period is referred to as “specified-cell initializing subfield”. A subfield where the selective initializing operation is performed in the initializing period is referred to as “selective initializing subfield”.

In addition to the above specified-cell initializing subfield and selective initializing subfield, the structure of this exemplary embodiment includes the following subfields: a non-initializing subfield where no initializing operation is performed in all the discharge cells in the initializing period; and an all-cell initializing subfield where a forced initializing operation is performed in all the discharge cells in the initializing period. That is, the non-initializing subfield is a subfield where no initializing discharge by up-ramp voltage is caused in all the discharge cells in the initializing period, and the all-cell initializing subfield is a subfield where an initializing discharge by up-ramp voltage is caused in all the discharge cells in the initializing period.

In this exemplary embodiment, one field is formed of eight subfields (the first SF, and the second SF through the eighth SF). The first SF is either of a specified-cell initializing subfield, a non-initializing subfield, and an all-cell initializing subfield. The second SF through the eighth SF are selective initializing subfields. With this structure, the light emission unrelated to image display is only the light emission caused by the discharge in the forced initializing operation in the first SF. Therefore, luminance of black level, i.e. luminance in an area displaying a black picture where no sustain discharge is caused, is determined only by the weak light emission in the forced initializing operation. This structure can reduce the luminance of black level in a display image and enhance the contrast.

Hereinafter, a field having a specified-cell initializing subfield (e.g. the first SF) and a plurality of selective initializing subfields (e.g. the second SF through the eighth SF) is referred to as “specified-cell initializing field”. A field having a non-initializing subfield (e.g. the first SF) and a plurality of selective initializing subfields (e.g. the second SF through the eighth SF) is referred to as “non-initializing field”. A field having an all-cell initializing subfield (e.g. the first SF) and a plurality of selective initializing subfields (e.g. the second SF through the eighth SF) is referred to as “all-cell initializing field”.

However, in this exemplary embodiment, the number of subfields, or the luminance weight of each subfield is not limited to the above values. The subfield structure may be switched according to image signals, for example.

Next, driving voltage waveforms are described, using the specified-cell initializing field as an example.

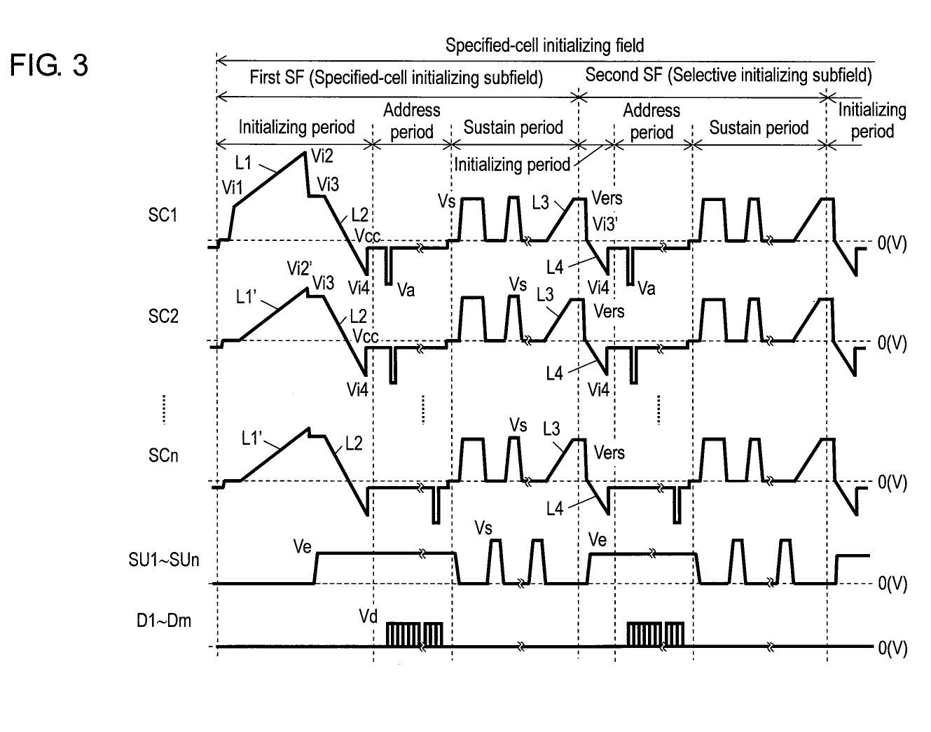

FIG. 3 is a waveform chart of driving voltages applied to the respective electrodes of panel 10 in accordance with the first exemplary embodiment of the present invention. FIG. 3 shows driving waveforms applied to the following electrodes: scan electrode SC1 for undergoing an address operation first in the address periods; scan electrode SC2 for undergoing an address operation second in the address periods; scan electrode SCn for undergoing an address operation last in the address periods (e.g. scan electrode SC1080); sustain electrode SU1 through sustain electrode SUn; and data electrode D1 through data electrode Dm.

FIG. 3 shows driving voltage waveforms in two subfields: the first subfield (first SF), i.e. a specified-cell initializing subfield; and the second subfield (second SF), i.e. a selective initializing subfield. Scan electrode SCi, sustain electrode SUi, and data electrode Dk to be described below show the electrodes selected among the respective electrodes, according to subfield data. This subfield data is data showing light emission and no light emission in each subfield.

First, the first SF, i.e. a specified-cell initializing subfield, is described.

FIG. 3 shows a structure where a forced initializing waveform for causing an initializing discharge in the discharge cells irrespective of the operation in the immediately preceding subfield is applied to scan electrodes SC(1+3×N) in the (1+3×N)-th positions (N being integers) from the top, and a non-initializing waveform for causing no initializing discharge by up-ramp voltage in the discharge cells is applied to scan electrodes 22 other than electrodes SC(1+3×N).

In the first half of the initializing period of the first SF, 0 (V) is applied to each of data electrode D1 through data electrode Dm and sustain electrode SU1 through sustain electrode SUn. To scan electrodes SC(1+3×N), predetermined voltage Vi1, and ramp voltage (hereinafter, referred to as “up-ramp voltage”) L1, which rises from voltage Vi1 toward voltage Vi2 gently (e.g. with a gradient of approximately 0.5 V/μsec), are applied. At this time, voltage Vi1 is a voltage lower than a breakdown voltage with respect to sustain electrodes SU(1+3×N), and voltage Vi2 is a voltage exceeding the breakdown voltage with respect to sustain electrodes SU(1+3×N). While up-ramp voltage L1 is rising, a weak initializing discharge continuously occurs between scan electrodes SC(1+3×N) and sustain electrodes SU(1+3×N), and between scan electrodes SC(1+3×N) and data electrode D1 through data electrode Dm. Then, negative wall voltage accumulates on scan electrodes SC(1+3×N); positive wall voltage accumulates on data electrode D1 through data electrode Dm intersecting with scan electrodes SC(1+3×N), and sustain electrodes SU(1+3×N). Here, this wall voltage on the electrodes means the voltage generated by the wall charge that is accumulated on the dielectric layers covering the electrodes, the protective layer, the phosphor layers, or the like.

In the second half of the initializing period, the voltage applied to scan electrodes SC(1+3×N) is lowered from voltage Vi2 to voltage Vi3, which is lower than voltage Vi2. Positive voltage Vi2 is applied to sustain electrode SU1 through sustain electrode SUn and 0 (V) is applied to data electrode D1 through data electrode Dm. To scan electrodes SC(1+3×N), ramp voltage (hereinafter, referred to as “down-ramp voltage”) L2, which falls from voltage Vi3 toward negative voltage Vi4 gently (e.g. with a gradient of approximately −0.5 V/μsec), is applied. At this time, voltage Vi3 is a voltage lower than the breakdown voltage with respect to sustain electrodes SU(1+3×N), and voltage Vi4 is a voltage exceeding the breakdown voltage with respect to sustain electrodes SU(1+3×N).

During this application, a weak initializing discharge occurs between scan electrodes SC(1+3×N) and sustain electrodes SU(1+3×N), and between scan electrodes SC(1+3×N) and data electrode D1 through data electrode Dm. This weak discharge reduces the negative wall voltage on scan electrodes SC(1+3×N), and the positive wall voltage on sustain electrodes SU(1+3×N), and adjusts the positive wall voltage on data electrode D1 through data electrode Dm intersecting with scan electrodes SC(1+3×N) to a value appropriate for the address operation.

The above waveform is the forced initializing waveform for causing an initializing discharge in the discharge cells irrespective of the operation in the immediately preceding subfield. The above operation of applying the forced initializing waveform to scan electrodes 22 is the forced initializing operation.

On the other hand, the following operations are performed on scan electrodes 22 other than scan electrodes SC(1+3×N). That is, instead of application of predetermined voltage Vi1, 0 (V) is kept, and up-ramp voltage L1′, which gently rises from 0 (V) toward voltage Vi2′, is applied in the first half of the initializing period of the first SF. Here, this up-ramp voltage L1′ continues to rise for a period equal to that of up-ramp voltage L1 with a gradient equal to that of up-ramp voltage L1. Therefore, voltage Vi2′ is equal to a voltage obtained by subtracting voltage Vi1 from voltage Vi2. At this time, each voltage and up-ramp voltage L1′ are set such that voltage Vi2′ is lower than the breakdown voltage with respect to sustain electrodes 23. With this setting, substantially no discharge occurs in the discharge cells applied with up-ramp voltage L1′.

In the second half of the initializing period, down-ramp voltage L2 is applied to electrodes 22 other than scan electrodes SC(1+3×N), in a manner similar to that of scan electrodes SC(1+3×N).

The above waveform is the non-initializing waveform for causing no initializing discharge by up-ramp voltage in the discharge cells. The above operation of applying the non-initializing waveform to scan electrodes 22 is the non-initializing operation.

The forced initializing waveform in the present invention is not limited to the above waveform. Any waveform may be used as long as the waveform causes an initializing discharge in the discharge cells irrespective of the operation in the immediately preceding subfield. The non-initializing waveform in the present invention is not limited to the above waveform. The non-initializing waveform in this exemplary embodiment only shows an example of the waveform for causing no initializing discharge in the discharge cells. Any waveform, e.g. a waveform for clamping the voltage to 0 (V), may be used as long as the waveform causes no initializing discharge.

In this manner, the specified-cell initializing operation in the initializing period of a specified-cell initializing subfield is completed. That is, the forced initializing waveform is applied to predetermined ones (e.g. scan electrodes SC(1+3×N)) of scan electrodes 22 and the non-initializing waveform is applied to the other ones of scan electrodes 22, for the forced initializing operation in the specified discharge cells and the non-initializing operation in the other discharge cells.

In the subsequent address period, scan pulse voltage Va is sequentially applied to scan electrode SC1 through scan electrode SCn. Positive address pulse voltage Vd is applied to data electrode Dk (k being 1 through m) corresponding to a discharge cell to be lit among data electrode D1 through data electrode Dm. Thus, an address discharge is caused selectively in the corresponding discharge cells.

Specifically, first, voltage Ve is applied to sustain electrode SU1 through sustain electrode SUn, and voltage Vcc is applied to scan electrode SC1 through scan electrode SCn.

Next, negative scan pulse voltage Va is applied to scan electrode SC1 in the first position (the first row) from the top, and positive address pulse voltage Vd is applied to data electrode Dk (k being 1 through m) of the discharge cell to be lit in the first row among data electrode D1 through data electrode Dm. At this time, the voltage difference in the intersecting part of data electrode Dk and scan electrode SC1 is obtained by adding the difference between the wall voltage on data electrode Dk and the wall voltage on scan electrode SC1 to a difference in externally applied voltage (voltage Vd−voltage Va), and thus exceeds the breakdown voltage. Then, a discharge occurs between data electrodes Dk and scan electrode SC1. Since voltage Ve is applied to sustain electrode SU1 through sustain electrode SUn, the voltage difference between sustain electrode SU1 and scan electrode SC1 is obtained by adding the difference between the wall voltage on sustain electrode SU1 and the wall voltage on scan electrode SC1 to a difference in externally applied voltage (voltage Ve-voltage Va). At this time, setting voltage Ve to a value slightly lower than the breakdown voltage can make a state where a discharge is likely to occur but not actually occurs between sustain electrode SU1 and scan electrode SC1. With this setting, the discharge caused between data electrode Dk and scan electrode SC1 can trigger a discharge between the areas of sustain electrode SU1 and scan electrode SC1 intersecting with data electrode Dk. Thus, an address discharge occurs in the discharge cells to be lit. Positive wall voltage accumulates on scan electrode SC1 and negative wall voltage accumulates on sustain electrode SU1. Negative wall voltage also accumulates on data electrode Dk.

In this manner, the address discharge is caused in the discharge cells to be lit in the first row so as to accumulate wall voltages on the corresponding electrodes. On the other hand, the voltage in the intersecting parts of scan electrode SC1 and data electrode D1 through data electrode Dm applied with no address pulse voltage Vd does not exceed the breakdown voltage, and thus no address discharge occurs. The above address operation is repeated until the operation reaches the discharge cells in the n-th row, and the address period is completed.

In the subsequent sustain period, sustain pulses equal in number to the luminance weight multiplied by a predetermined luminance magnification are alternately applied to display electrode pairs 24. Thereby, a sustain discharge is caused in the discharge cells having undergone an address discharge. In this manner, the discharge cells having undergone an address discharge are caused to emit light.

Specifically, first, positive sustain pulse voltage Vs is applied to scan electrode SC1 through scan electrode SCn, and a ground potential as a base potential, i.e. 0 (V), is applied to sustain electrode SU1 through sustain electrode SUn. Then, in the discharge cells having undergone an address discharge, the voltage difference between scan electrode SCi and sustain electrode SUi is obtained by adding the difference between the wall voltage on scan electrode SCi and the wall voltage on sustain electrode SUi to sustain pulse voltage Vs, and thus exceeds the breakdown voltage.

Then, a sustain discharge occurs between scan electrode SCi and sustain electrode SUi, and ultraviolet light generated at this time causes phosphor layers 35 to emit light. Thus, negative wall voltage accumulates on scan electrode SCi, and positive wall voltage accumulates on sustain electrode SUi. Positive wall voltage also accumulates on data electrode Dk. In the discharge cells having undergone no address discharge in the address period, no sustain discharge occurs.

Subsequently, 0 (V) as the base potential is applied to scan electrode SC1 through scan electrode SCn, and sustain pulse voltage Vs is applied to sustain electrode SU1 through sustain electrode SUn. In the discharge cell having undergone a sustain discharge, the voltage difference between sustain electrode SUi and scan electrode SCi exceeds the breakdown voltage. Thereby, a sustain discharge occurs between sustain electrode SUi and scan electrode SCi again. Thus, negative wall voltage accumulates on sustain electrode SUi, and positive wall voltage accumulates on scan electrode SCi. Similarly, sustain pulses equal in number to the luminance weight multiplied by the luminance magnification are alternately applied to scan electrode SC1 through scan electrode SCn and sustain electrode SU1 through sustain electrode SUn so as to cause a potential difference between the electrodes of display electrode pairs 24. Thereby, the sustain discharge is continued in the discharge cells having undergone an address discharge in the address period.

After the sustain pulses have been generated in the sustain period, ramp voltage (hereinafter, referred to as “erasing ramp voltage”) L3 is applied to scan electrode SC1 through scan electrode SCn while 0 (V) is applied to sustain electrode SU1 through sustain electrode SUn and data electrode D1 through data electrode Dm. Here, this erasing ramp voltage rises gently (e.g. with a gradient of approximately 10 V/μsec) from 0 (V) toward voltage Vers, which exceeds the breakdown voltage. Thereby, between sustain electrode SUi and scan electrode SCi in the discharge cell having undergone a sustain discharge, a weak discharge continuously occurs. The charged particles generated by this weak discharge accumulate on sustain electrode SUi and scan electrode SCi, as wall charge, so as to reduce the voltage difference between sustain electrode SUi and scan electrode SCi. With this operation, the wall voltage on scan electrode SCi and the wall voltage on sustain electrode SUi are reduced to the difference between the voltage applied to scan electrode SCi and the breakdown voltage, e.g. a level of (voltage Vers-breakdown voltage), while the positive wall voltage is left on data electrode Dk.

Thereafter, the voltage applied to scan electrode SC1 through scan electrode SCn is returned to 0 (V), and the sustain operation in the sustain period is completed.

Next, the second SF, a selective initializing subfield, is described.

In the initializing period of the second SF, a selective initializing waveform is applied to all scan electrodes 22. The selective initializing waveform in this exemplary embodiment is a driving voltage waveform where the first half of the forced initializing waveform is omitted. Specifically, voltage Ve is applied to sustain electrode SU1 through sustain electrode SUn, 0 (V) is applied to data electrode D1 through data electrode Dm, and down-ramp voltage L4 is applied to scan electrode SC1 through scan electrode SCn. Here, down-ramp voltage L4 falls from a voltage lower than the breakdown voltage (e.g. 0 (V)) toward negative voltage Vi4 with a gradient equal to that of down-ramp voltage L2.

This application causes a weak initializing discharge in the discharge cells having undergone a sustain discharge in the sustain period of the immediately preceding subfield (the first SF in FIG. 3). Thus, the wall voltages on scan electrode SCi and sustain electrode SUi are reduced, and the wall voltage on data electrode Dk (k being 1 through m) is adjusted to a value appropriate for the address operation.

The above waveform is the selective initializing waveform for causing an initializing discharge only in the discharge cells having undergone a sustain discharge in the sustain period of the immediately preceding subfield. The above operation of applying the selective initializing waveform to all scan electrodes 22 is the selective initializing operation. In this manner, the selective initializing operation in the initializing period of the selective initializing subfield is completed.

The selective initializing waveform of the present invention is not limited to the above waveform. Any waveform may be used as long as the waveform causes an initializing discharge only in the discharge cells having undergone a sustain discharge in the sustain period of the immediately preceding subfield. For example, in this exemplary embodiment, a description is provided for a structure where down ramp voltage L4 is generated with one gradient. However, down-ramp voltage L4 may be divided for a plurality of sub-periods and generated with gradients different in the respective sub-periods.

In the address period of the second SF, the driving waveforms identical with those in the address period of the first SF are applied to the respective electrodes. In the sustain period of the second SF, the driving waveforms identical with those in the sustain period of the first SF, except for the number of sustain pulses, are applied to the respective electrodes.

In the third SF and the subfields thereafter, the driving waveforms identical with those in the second SF, except for the number of sustain pulses in the sustain periods, are applied to the respective electrodes.

The above description has outlined the driving voltage waveforms applied to the respective electrodes of panel 10 in this exemplary embodiment.

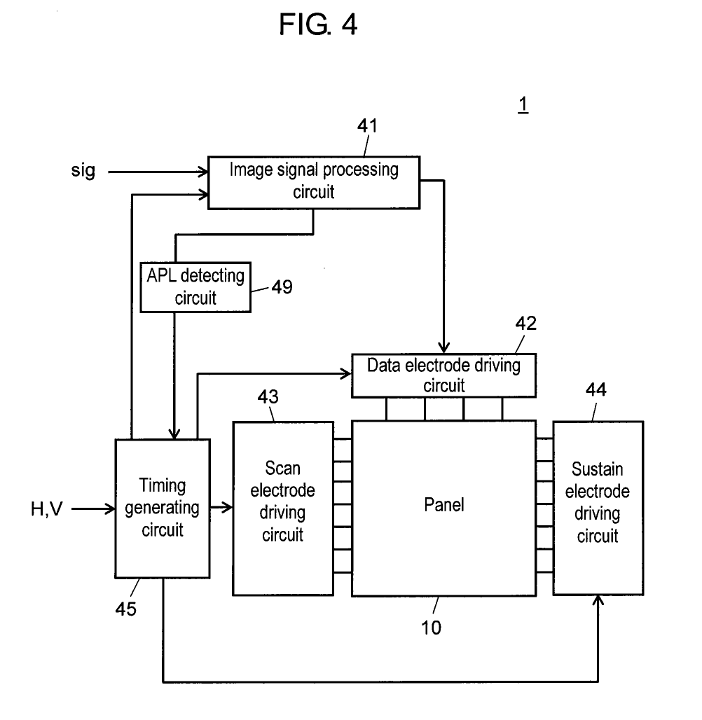

Next, the structure of a plasma display device in this exemplary embodiment is described. FIG. 4 is a circuit block diagram of plasma display device 1 in accordance with the first exemplary embodiment of the present invention. Plasma display device 1 has the following elements:
panel 10;
image signal processing circuit 41;
data electrode driving circuit 42;
scan electrode driving circuit 43;
sustain electrode driving circuit 44;
timing generating circuit 45;
APL detecting circuit 49; and
power supply circuits (not shown) for supplying power necessary for each circuit block.

Image signal processing circuit 41 converts input image signal sig into subfield data showing light emission and no light emission in each subfield, according to the number of pixels in panel 10.

APL detecting circuit 49 detects an average picture level (hereinafter, abbreviated as “APL”) of an input image signal by a generally-known method, e.g. accumulating the luminance values of the image signal in one field period, and transmits the detection result to timing generating circuit 45.

Timing generating circuit 45 generates various timing signals for controlling the operation of each circuit block, according to horizontal synchronizing signal H, vertical synchronizing signal V, and the detection result output from APL detecting circuit 49, and supplies the timing signals to the respective circuit blocks (image signal processing circuit 41, data electrode driving circuit 42, scan electrode driving circuit 43, and sustain electrode driving circuit 44).

Data electrode driving circuit 42 converts subfield data in each subfield into signals corresponding to each of data electrode D1 through data electrode Dm, and drives each of data electrode D1 through data electrode Dm, in response to the timing signals supplied from timing generating circuit 45.

Scan electrode driving circuit 43 has the following elements:
an initializing waveform generating circuit for generating initializing waveforms to be applied to scan electrode SC1 through scan electrode SCn in the initializing periods;
a sustain pulse generating circuit for generating sustain pulses to be applied to scan electrode SC1 through scan electrode SCn in the sustain periods; and
a scan pulse generating circuit having a plurality of scan electrode driving integrated circuits (hereinafter, simply referred to as “scan ICs”), for generating a scan pulse to be applied to scan electrode SC1 through scan electrode SCn in the address periods. The scan electrode driving circuit drives each of scan electrode SC1 through scan electrode SCn, in response to the timing signals supplied from timing generating circuit 45.

Sustain electrode driving circuit 44 has a sustain pulse generating circuit and a circuit for generating voltage Ve, and drives sustain electrode SU1 through sustain electrode SUn, in response to the timing signals supplied from timing generating circuit 45.

Next, the details and operation of scan electrode driving circuit 43 are described.

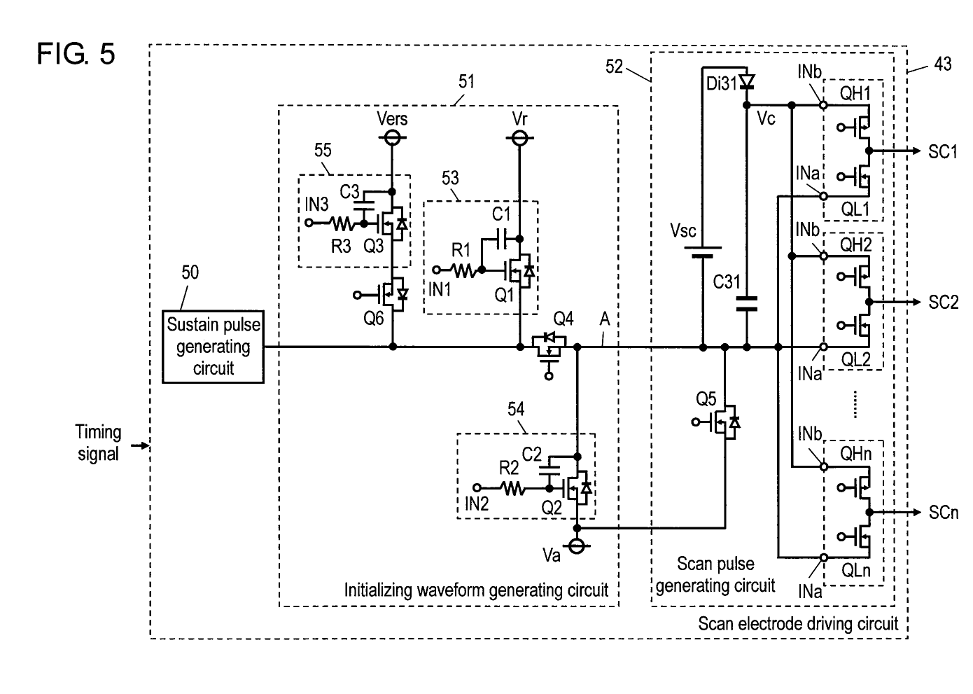

FIG. 5 is a circuit diagram showing a configuration example of scan electrode driving circuit 43 of plasma display device 1 in accordance with the first exemplary embodiment of the present invention. Scan electrode driving circuit 43 has the following elements:
sustain pulse generating circuit 50 for generating sustain pulses;
initializing waveform generating circuit 51 for generating initializing waveforms; and
scan pulse generating circuit 52 for generating scan pulses.

Each output terminal of scan pulse generating circuit 52 is connected to corresponding one of scan electrode SC1 through scan electrode SCn of panel 10. In this exemplary embodiment, the voltage input to scan pulse generating circuit 52 is denoted as “reference potential A”. In the following description, the operation of bringing a switching element into conduction is denoted as “ON”, and the operation of bringing a switching element out of conduction is denoted as “OFF”. A signal for setting a switching element to ON is denoted as “Hi”, and a signal for setting a switching element to OFF is denoted as “Lo”.

FIG. 5 shows a separating circuit using switching element Q4, for electrically separating sustain pulse generating circuit 50, a circuit based on voltage Vr (e.g. Miller integrating circuit 53), and a circuit based on voltage Vers (e.g. Miller integrating circuit 55) from a circuit based on negative voltage Va (e.g. Miller integrating circuit 54) while the latter circuit is operated. The diagram also shows a separating circuit using switching element Q6, for electrically separating a circuit based on voltage Vers (e.g. Miller integrating circuit 55), which is lower than voltage Vr, from a circuit based on voltage Vr (e.g. Miller integrating circuit 53) while the latter circuit is operated.

Sustain pulse generating circuit 50 has a generally-used power recovery circuit and clamp circuit, and generates sustain pulses by switching the respective switching elements included therein, in response to the timing signals output from timing generating circuit 45. In FIG. 5, the details of the paths of the timing signals are omitted.

Scan pulse generating circuit 52 has switching element QH1 through switching element QHn and switching element QL1 through switching element QLn for applying a scan pulse to n scan electrode SC1 through scan electrode SCn, respectively. One terminal of switching element QHj (j being 1 through n) is interconnected to one terminal of switching element QLj. The interconnected part forms an output terminal of scan pulse generating circuit 52 and is connected to scan electrode SCj. The other terminal of switching element QHj is input terminal INb; the other terminal of switching element QLj is input terminal INa. Switching element QH1 through switching element QHn and switching element QL1 through switching element QLn are grouped in a plurality of outputs and formed into ICs. These ICs are scan ICs.

Scan pulse generating circuit 52 has the following elements:
switching element Q5 for connecting reference potential A to negative voltage Va in the address periods; and
power supply VSC, diode D131, and capacitor C31 for generating voltage Vc, where voltage Vsc is superimposed on reference potential A.

Voltage Vc is connected to input terminal INb of each of switching element QH1 through switching element QHn; reference potential A is connected to input terminal INa of each of switching element QL1 through switching element QLn.

In scan pulse generating circuit 52 thus configured, switching element Q5 is set to ON so as to make reference potential A equal to negative voltage Va, and negative voltage Va is input to input terminal INa, in the address periods. Voltage Vc (voltage Vcc in FIG. 3), i.e. negative voltage Va+voltage Vsc, is applied to input terminal INb. Then, according to subfield data, the following operations are performed. To scan electrode SCi to be applied with a scan pulse, negative scan pulse voltage Va is applied via switching element QLi, by setting switching element QHi to OFF and switching element QLi to ON. To scan electrode SCh to be applied with no scan pulse (h being 1 through n except i), voltage Va+voltage Vsc is applied via switching element QHh, by setting switching element QLh to OFF and switching element QHh to ON.

Scan pulse generating circuit 52 is controlled by timing generating circuit 45 so as to output the voltage waveforms in sustain pulse generating circuit 50, in the sustain periods.

The details of the operation of scan pulse generating circuit 52 in the initializing periods will be described later.

Initializing waveform generating circuit 51 has Miller integrating circuit 53, Miller integrating circuit 54, and Miller integrating circuit 55. In FIG. 5, the input terminal of Miller integrating circuit 53 is shown as input terminal IN1, the input terminal of Miller integrating circuit 54 as input terminal IN2, and the input terminal of Miller integrating circuit 55 as input terminal IN3. Each of Miller integrating circuit 53 and Miller integrating circuit 55 is a ramp voltage generating circuit for generating a rising ramp voltage. Miller integrating circuit 54 is a ramp voltage generating circuit for generating a falling ramp voltage.

Miller integrating circuit 53 has switching element Q1, capacitor C1, and resistor R1. In the initializing operation, this Miller integrating circuit generates up-ramp voltage L1′, by causing reference potential A of scan electrode driving circuit 43 to rise to voltage Vi2′ gently (e.g. with a gradient of 0.5 V/μsec) in a ramp form.

Miller integrating circuit 55 has switching element Q3, capacitor C3, and resistor R3. At the end of each sustain period, this Miller integrating circuit generates erasing ramp voltage L3, by causing reference potential A to rise to voltage Vers with a gradient (e.g. 10 V/μsec) steeper than that of up-ramp voltage L1.

Miller integrating circuit 54 has switching element Q2, capacitor C2, and resistor R2. In the initializing operation, this Miller integrating circuit generates down-ramp voltage L2, by causing reference potential A to fall to voltage Vi4 gently (e.g. with a gradient of −0.5 V/μsec) in a ramp form.

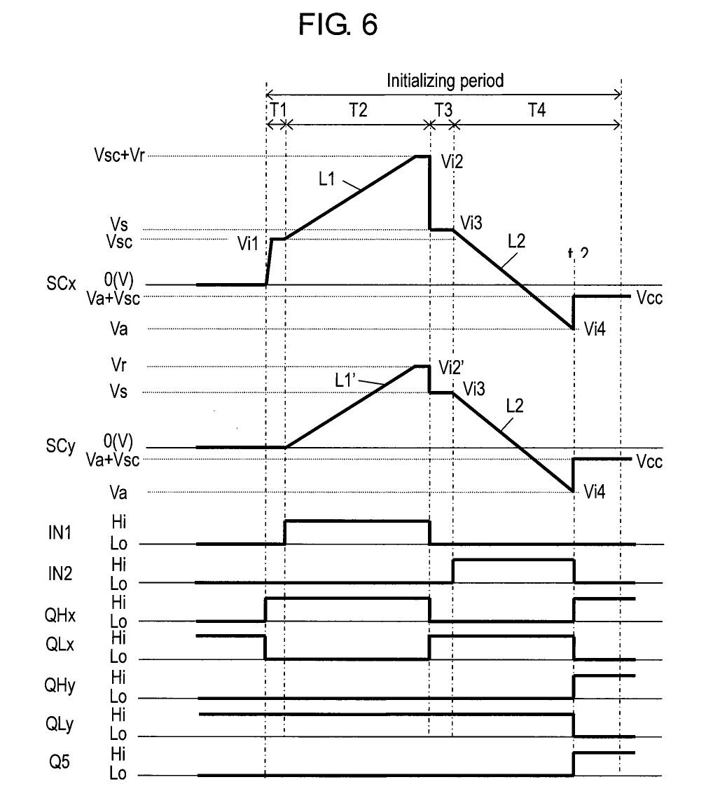

Next, with reference to FIG. 6, a description is provided for the operation of generating a forced initializing waveform and a non-initializing waveform in the initializing period of a specified-cell initializing subfield.

FIG. 6 is a timing chart for explaining an example of the operation of scan electrode driving circuit 43 in the initializing period of a specified-cell initializing subfield in accordance with the first exemplary embodiment of the present invention. In this chart, scan electrode 22 to be applied with a forced initializing waveform is denoted as “scan electrode SCx”, and scan electrode 22 to be applied with a non-initializing waveform as “scan electrode SCy”.

The description of the operation of scan electrode driving circuit 43 when a selective initializing waveform is generated in a selective initializing subfield is omitted. However, the operation of generating down-ramp voltage L4, i.e. a selective initializing waveform, is the same as the operation of generating down-ramp voltage L2 of FIG. 6.

The non-initializing operation in a non-initializing subfield is the operation of generating and applying a non-initializing waveform to all scan electrodes 22 in the initializing period. The all-cell initializing operation in an all-cell initializing subfield is the operation of generating and applying a forced initializing waveform to all scan electrodes 22 in the initializing period. Thus, the description of the operations of scan electrode driving circuit 43 in the initializing period of a non-initializing subfield and in the initializing period of an all-cell initializing subfield is omitted.

In FIG. 6, the initializing period is divided into four sub-periods shown by sub-period T1 through sub-period T4, and each sub-period is described. In the following description, voltage Vi1 is equal to voltage Vsc, voltage Vi2 is equal to voltage Vsc+voltage Vr, voltage Vi2′ is equal to voltage Vr, voltage Vi3 is equal to voltage Vs used to generate sustain pulses, and voltage Vi4 is equal to negative voltage Va. In the chart, a signal for setting a switching element to ON is denoted as “Hi”, and a signal for setting a switching element to OFF as “Lo”.

FIG. 6 shows an example where voltage Vs is set to a value higher than voltage Vsc. However, voltage Vs and voltage Vsc may be at an equal value, or voltage Vs may be lower than voltage Vsc.

First, before sub-period T1, the clamp circuit of sustain pulse generating circuit 50 is operated so as to set reference potential A to 0 (V). Next, switching element QH1 through switching element QHn are set to OFF and switching element QL1 through switching element QLn are set to ON so as to apply reference potential A, i.e. 0 (V), to scan electrode SC1 through scan electrode SCn.

### (Sub-Period T1)

In sub-period T1, switching element QHx connected to scan electrode SCx is set to ON, and switching element QLx connected thereto is set to OFF. Thereby, voltage Vc where voltage Vsc is superimposed on reference potential A (0 (V) at this time), i.e. voltage Vc=voltage Vsc, is applied to scan electrode SCx to be applied with a forced initializing waveform.

On the other hand, switching element QHy connected to scan electrode SCy is kept at OFF, and switching element QLy connected thereto is kept at ON. Thereby, reference potential A, i.e. 0 (V), is applied to scan electrode SCy to be applied with a non-initializing waveform.

### (Sub-Period T2)

In sub-period T2, switching element QH1 through switching element QHn, and switching element QL1 through switching element QLn are kept in a state equal to that in sub-period T1. That is, switching element QHx connected to scan electrode SCx is kept at ON, and switching element QLx connected thereto is kept at OFF. Switching element QHy connected to scan electrode SCy is kept at OFF, and switching element QLy connected thereto is kept at ON.

Next, input terminal IN1 of Miller integrating circuit 53 for generating up-ramp voltage L1′ is set to “Hi”. Specifically, a predetermined constant current is input to input terminal IN1. Then, the constant current flows toward capacitor C1, the source voltage of switching element Q1 rises in a ramp form, and reference potential A starts to rise from 0 (V) in a ramp form. This voltage rise can be continued in the period during which input terminal IN1 is set to “Hi” or until reference potential A reaches voltage Vr.

At this time, the constant current input to input terminal IN1 is generated such that the gradient of the ramp voltage is at a desired value (e.g. 0.5 V/μsec). In this manner, up-ramp voltage L1′, which rises from 0 (V) toward voltage Vi2′ (equal to voltage Vr, in this exemplary embodiment), is generated.

Since switching element QHy is set to OFF and switching element QLy is set to ON, this up-ramp voltage L1′ is applied to scan electrode SCy without any change.

On the other hand, since switching element QHx is set to ON and switching element QLx is set to OFF, a voltage where voltage Vsc is superimposed on this up-ramp voltage L1′ is applied to scan electrode SCx. That is, the application voltage is up-ramp voltage L1, which rises from voltage Vi1 (equal to voltage Vsc, in this exemplary embodiment) toward voltage Vi2 (equal to voltage Vsc+voltage Vr, in this exemplary embodiment).

### (Sub-Period T3)

In sub-period T3, input terminal IN1 is set to “Lo”. Specifically, the input of the constant current to input terminal IN1 is stopped. Thus, the operation of Miller integrating circuit 53 is stopped. Switching element QH1 through switching element QHn are set to OFF and switching element QL1 through switching element QLn are set to ON so as to apply reference potential A to scan electrode SC1 through scan electrode SCn. Further, the clamp circuit of sustain pulse generating circuit 50 is operated so as to set reference potential A to voltage Vs. Thereby, the voltage of scan electrode SC1 through scan electrode SCn falls to voltage Vi3 (equal to voltage Vs, in this exemplary embodiment).

### (Sub-Period T4)

In sub-period T4, switching element QH1 through switching element QHn, and switching element QL1 through switching element QLn are kept in a state equal to that in sub-period T3.

Next, input terminal IN2 of Miller integrating circuit 54 for generating down-ramp voltage L2 is set to “Hi”. Specifically, a predetermined constant current is input to input terminal IN2. Thereby, the constant current flows toward capacitor C2, and the drain voltage of switching element Q2 starts to fall in a ramp form. The output voltage of scan electrode driving circuit 43 starts to fall toward negative voltage Vi4 in a ramp form. This voltage drop can be continued in the period during which input terminal IN2 is set to “Hi” or until reference potential A reaches voltage Va.

At this time, the constant current input to input terminal IN2 is generated such that the gradient of the ramp voltage is at a desired value (e.g. −0.5 V/μsec).

When the output voltage of scan electrode driving circuit 43 reaches negative voltage Vi4 (equal to voltage Va, in this exemplary embodiment), input terminal IN2 is set to “Lo”. Specifically, the constant current input to input terminal IN2 is stopped. Thus, the operation of Miller integrating circuit 54 is stopped.

In this manner, down-ramp voltage L2, which falls from voltage Vi3 (equal to voltage Vs, in this exemplary embodiment) toward negative voltage Vi4, is generated and applied to scan electrode SC1 through scan electrode SCn.

After the operation of Miller integrating circuit 54 is stopped by setting input terminal IN2 to “Lo”, switching element Q5 is set to ON so as to set reference potential A to voltage Va. Further, switching element QH1 through switching element QHn are set to ON, and switching element QL1 through switching element QLn are set to OFF. Thereby, voltage Vc where voltage Vsc is superimposed on reference potential A, i.e. voltage Vcc (equal to voltage Va+voltage Vsc, in this exemplary embodiment), is applied to scan electrode SC1 through scan electrode SCn, as preparation for the subsequent address period. In this exemplary embodiment, a forced initializing waveform and a non-initializing waveform are generated in the initializing period of a specified-cell initializing subfield in this manner. The forced initializing waveform and the non-initializing waveform can be applied to scan electrodes 22 selectively, e.g. the forced initializing waveform is applied to scan electrode SCx and the non-initializing waveform is applied to scan electrode SCy, by controlling switching element QH1 through switching element QHn and switching element QL1 through switching element QLn. In a similar manner, the following operations can also be performed. Only the non-initializing waveform is generated and applied to all scan electrodes 22 in the initializing period of a non-initializing subfield. Only the forced initializing waveform is generated and applied to all scan electrodes 22 in the initializing period of an all-cell initializing subfield.

Each of down-ramp voltage L2 and down-ramp voltage L4 may be dropped to voltage Va as shown in FIG. 6. However, for example, the voltage drop may be stopped when the falling voltage reaches the voltage where predetermined positive voltage Vset2 is superimposed on voltage Va. Further, each of down-ramp voltage L2 and down-ramp voltage L4 may be raised immediately after having reached a preset voltage. However, for example, after the falling voltage has reached a preset voltage, the preset voltage may be maintained for a fixed period.

Next, a description is provided for patterns of forced initializing waveforms and non-initializing waveforms generated in this exemplary embodiment.

One of important factors in enhancing image display quality in plasma display device 1 is to enhance the contrast of the image displayed on panel 10. In order to enhance the contrast in panel 10, at least either of the following operations is performed. The maximum value of the luminance of the display image is increased, or the minimum value of the luminance of the display image, i.e. luminance of black level, is decreased. At this time, in consideration of the general environment for viewing a television at home, decreasing luminance of black level so as to enhance the contrast is considered more important in enhancing the image display quality.

Luminance of black level is changed by light emission unrelated to image display. Thus, the luminance of black level can be decreased by reducing the light emission unrelated to image display. Major examples of the light emission unrelated to image display include the light emission caused by initializing discharge. However, the above selective initializing operation causes no discharge in the discharge cells having undergone no sustain discharge in the immediately preceding subfield, and thus exerts substantially no influence on the brightness of luminance of black level. In contrast, the above forced initializing operation causes an initializing discharge in the discharge cells irrespective of the operation in the immediately preceding subfield, and thus exerts an influence on the brightness of luminance of black level.

Therefore, the luminance of black level of a display image can be decreased by reducing the frequency of forced initializing operations performed in each discharge cell.

On the other hand, the rate of lit discharge cells (also referred to as “light-emitting rate”) in the display of an image at a high APL is more than that in the display of an image at a low APL. Thus, the rate of discharge cells undergoing an address discharge is increased. When the number of address pulses generated is increased, a voltage drop in address pulses can be caused by the impedance of data electrode driving ICs, for example.

Further, the wall charge or priming particles formed by the initializing discharge in the discharge cells gradually decreases with a lapse of time. Thus, as the time intervals at which forced initializing operations are performed increase, the average value of the decrease in the amount of wall charge or priming particles increases.

The address operation is influenced by the wall charge or priming particles remaining in the discharge cells. In the display of an image where a voltage drop in address pulses is likely to occur, i.e. an image at a high APL where a large number of address pulses are generated, it is preferable to reduce the time interval from the initializing operation to the address operation, and cause an address discharge while a decrease in wall charge or priming particles is relatively small.

Then, in this exemplary embodiment, in the display of an image at a low APL, the time intervals at which forced initializing waveforms are applied to scan electrodes 22 are increased. In the display of an image at a high APL, the time intervals at which the forced initializing waveforms are applied to scan electrodes 22 are reduced. In this manner, the frequency of forced initializing waveforms to be generated is changed according to the magnitude of APL.

That is, in this exemplary embodiment, the following operations are performed. In the display of an image (at a low APL) where the rate of dark regions on the image display surface of panel 10 is relatively high and the image display quality can be considerably improved by reducing the luminance of black level, the frequency of initializing discharges caused by forced initializing waveforms is reduced so as to reduce the luminance of black level of the display image and enhance the contrast of the display image. In contrast, in the display of an image (at a high APL) where a relatively large number of address discharges tend to occur unstably, the frequency of initializing discharges caused by forced initializing waveforms is increased so as to cause the address discharge stably.

In this exemplary embodiment, in order to control the frequency of forced initializing waveforms to be generated, three types of fields are set: a specified-cell initializing field having a specified-cell initializing subfield and a plurality of selective initializing subfields; a non-initializing field having a non-initializing subfield and a plurality of selective initializing subfields; and an all-cell initializing field having an all-cell initializing subfield and a plurality of selective initializing subfields. Further, using any one or two of these three types of fields, a plurality of temporally consecutive fields forms one field group. A plurality of positionally consecutive scan electrodes 22 forms a scan electrode group.

Then, the combination of fields forming a field group is changed according to the APL such that the frequency of forced initializing waveforms to be applied to scan electrodes 22 is reduced as the APL decreases.

In this exemplary embodiment, the APL is divided into a plurality of numerical value ranges, and the combination of fields forming a field group is preset for each numerical value range. Further, when the detected APL is changed from a numerical value range to another numerical value range, the combination of fields forming a field group is changed.

Specifically, APL detecting circuit 49 compares the APL with a plurality of predetermined threshold values and outputs a signal showing the comparison result to timing generating circuit 45. The combination of fields forming a field group for each numerical value range is prestored in timing generating circuit 45. The timing generating circuit outputs a timing signal that is based on the comparison result output from APL detecting circuit 49 to each driving circuit such that panel 10 is driven in the combination of fields according to the detected APL. With this operation, the frequency of forced initializing waveforms applied to scan electrodes 22 can be changed according to the APL.

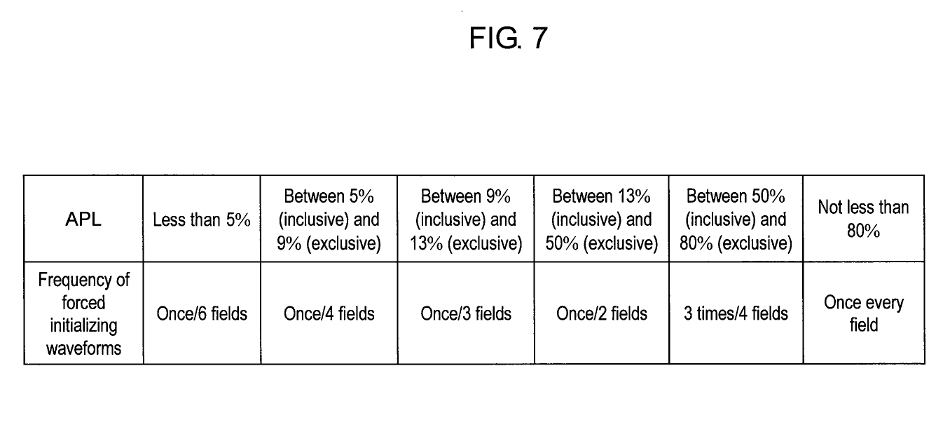

FIG. 7 is a chart showing an example of numerical value ranges of APL and frequencies of forced initializing waveforms set for the respective numerical value ranges in accordance with the first exemplary embodiment of the present invention.

In this exemplary embodiment, as shown in FIG. 7, in the display of an image at an APL less than 5%, the forced initializing waveforms are generated with a frequency of once every six fields. In the display of an image at an APL equal to or more than 5% and less than 9%, the forced initializing waveforms are generated once every four fields. In the display of an image at an APL equal to or more than 9% and less than 13%, the forced initializing waveforms are generated once every three fields. In the display of an image at an APL equal to or more than 13% and less than 50%, the forced initializing waveforms are generated once every two fields. In the display of an image at an APL equal to or more than 50% and less than 80%, the forced initializing waveforms are generated three times every four fields. In the display of an image at an APL equal to or more than 80%, the forced initializing waveforms are generated once every field.

Next, a description is provided for a specific structural example of the pattern of forced initializing waveforms and non-initializing waveforms set for each numerical value range.

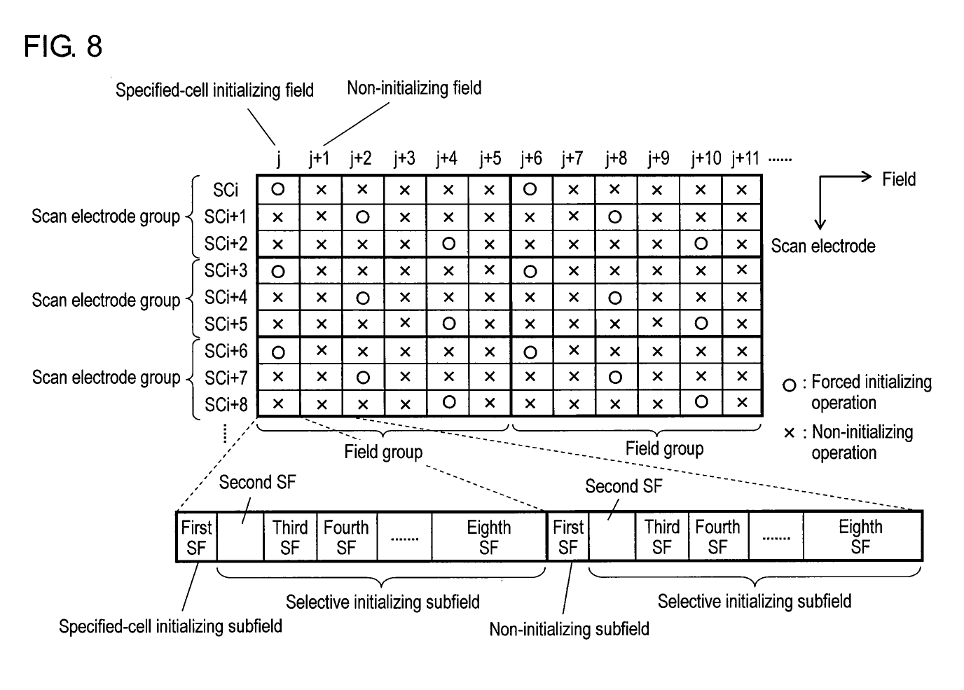

FIG. 8 is a schematic chart showing an example of the pattern of forced initializing waveforms and non-initializing waveforms generated when the frequency of forced initializing operations performed in each discharge cell is once every six fields in accordance with the first exemplary embodiment of the present invention. In FIG. 8, the horizontal axis shows fields, and the vertical axis shows scan electrodes 22.

In the example shown in FIG. 8, six temporally consecutive fields form one field group, and three positionally consecutive scan electrodes 22 form one scan electrode group. In the example of FIG. 8, the first SF is the above specified-cell initializing subfield or non-initializing subfield, and the remaining subfields (the second SF through the eighth SF) are the above selective initializing subfields. That is, in the example of FIG. 8, each field group is formed of two types of fields, i.e. a specified-cell initializing field and a non-initializing field.

The mark “o” in FIG. 8 shows that the forced initializing operation is performed in the initializing period of the first SF. That is, the forced initializing waveform having up-ramp voltage L1 and down-ramp voltage L2 shown in FIG. 6 is applied to scan electrodes 22. The mark “x” in FIG. 8 shows that the above non-initializing operation is performed in the initializing period of the first SF. That is, the non-initializing waveform having up-ramp voltage L1′ and down-ramp voltage L2 shown in FIG. 6 is applied to scan electrodes 22.

Hereinafter, a description is provided, using scan electrode SCi through scan electrode SCi+2 forming one scan electrode group and j field through j+5 field forming one field group, as an example. First, in the first SF of j field, a forced initializing waveform is applied to scan electrode SCi, and a non-initializing waveform is applied to scan electrode SCi+1 and scan electrode SCi+2.

In the first SF of subsequent j+1 field, a non-initializing waveform is applied to all scan electrodes 22.

In the first SF of subsequent j+2 field, a forced initializing waveform is applied to scan electrode SCi+1, and a non-initializing waveform is applied to scan electrode SCi and scan electrode SCi+2.

In the first SF of subsequent j+3 field, a non-initializing waveform is applied to all scan electrodes 22.

In the first SF of subsequent j+4 field, a forced initializing waveform is applied to scan electrode SCi+2, and a non-initializing waveform is applied to scan electrode SCi and scan electrode SCi+1.

In the first SF of subsequent j+5 field, a non-initializing waveform is applied to all scan electrodes 22.

In this manner, the operation in one scan electrode group in one field group is completed. In the other scan electrode groups, the operation the same as the above is performed. Also thereafter, the operation the same as the above is repeated in each field group. In the structure of FIG. 8, j field, j+2 field, and j+4 field, for example, are specified-cell initializing fields, and j+1 field, j+3 field, and j+5 field, for example, are non-initializing fields.

In this manner, in the example of FIG. 8, panel 10 is driven by generating the forced initializing waveforms and non-initializing waveforms selectively such that the number of forced initializing operations performed in each discharge cell is one in one field group (formed of six fields in the example of FIG. 8). This operation can reduce the frequency of forced initializing operations performed in each discharge cell, compared with that in the structure where the forced initializing operation is performed in all the discharge cells in each field. In the example of FIG. 8, the frequency can be reduced to one-sixth. Thus, the luminance of black level of the display image can be reduced.

In this exemplary embodiment, as shown in FIG. 8, the forced initializing waveforms are generated such that the number of scan electrodes 22 to be applied with the forced initializing waveforms is equal in the respective specified-cell initializing subfields in the field group formed of the plurality of specified-cell initializing fields. This is intended to prevent the occurrence of fine flickering called “flicker” in the display image.

When six fields are formed of one all-cell initializing field and five non-initializing fields, for example, the forced initializing operations can also be performed with a frequency of once every six fields. However, in this structure, all the discharge cells in panel 10 emit light with the discharge caused by the forced initializing operation at a rate of once every six fields. Thus, when an image to be updated in a cycle of 60 fields per second is displayed on panel 10, the luminance changes on the image display surface of panel 10 in a cycle of 10 fields per second. This cyclic change in luminance can be recognized by the user, as fine flickering, i.e. flickers, in the display image.

However, in this exemplary embodiment, as shown in FIG. 8, the forced initializing waveforms are generated such that the number of scan electrodes 22 to be applied with the forced initializing waveforms is equal in the respective specified-cell initializing subfields. Thus, the initializing discharges caused by the forced initializing operations can be distributed to the respective fields. Therefore, the emission luminance on the image display surface of panel 10 caused by the forced initializing operation can be made less than that of the all-cell initializing operation. In the example of FIG. 8, the emission luminance can be reduced to one-third. Further, even when the frequency of forced initializing operations performed in each discharge cell is once every six fields, the cycle of light emission caused by the forced initializing operations on the image display surface of panel 10 can be further shortened. In the example of FIG. 8, the cycle of light emission is reduced to once every two fields. This operation can prevent the occurrence of flickers.

The above “such that . . . is equal” does not mean exactly equal, and means that substantially “equal”. Slight variations are allowed.

In an image at a low APL, the number of address discharges and a voltage drop in address pulses are small, and thus the address discharge occurs in a relatively stable manner. Therefore, even when the time interval from the initializing operation to the address operation is long as shown in FIG. 8, the address discharge can be caused stably.

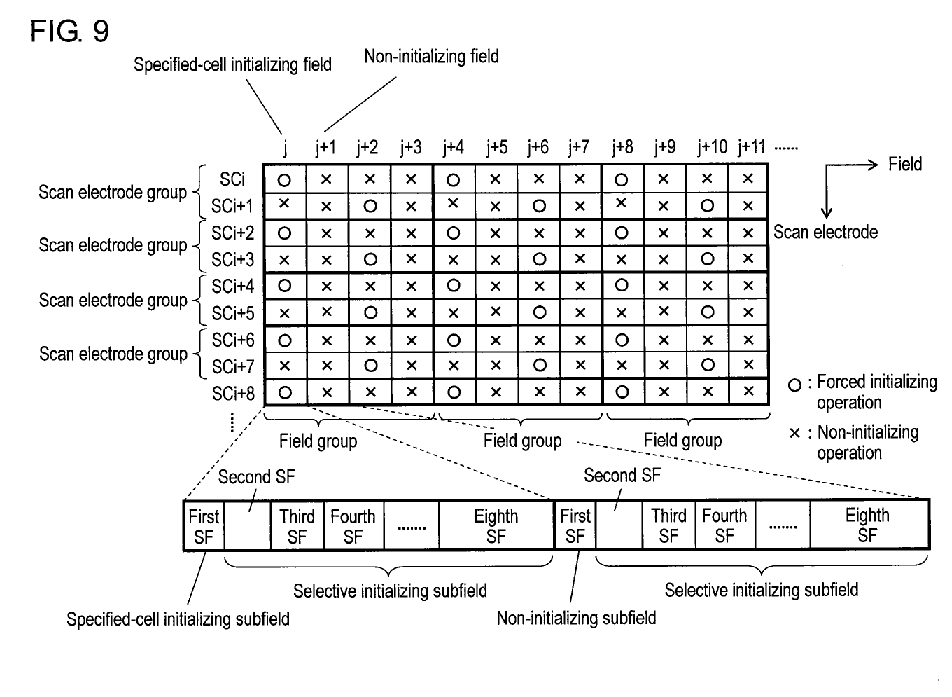

FIG. 9 is a schematic chart showing an example of the pattern of forced initializing waveforms and non-initializing waveforms generated when the frequency of forced initializing operations performed in each discharge cell is once every four fields in accordance with the first exemplary embodiment of the present invention.

In the example shown in FIG. 9, four temporally consecutive fields form one field group, and two positionally consecutive scan electrodes 22 form one scan electrode group. In the example of FIG. 9, similar to the example of FIG. 8, each field group is formed of two types of fields, i.e. a specified-cell initializing field and a non-initializing field.

Hereinafter, a description is provided, using scan electrode SCi and scan electrode SCi+1 forming one scan electrode group and j field through j+3 field forming one field group, as an example.

First, in the first SF of j field, a forced initializing waveform is applied to scan electrode SCi, and a non-initializing waveform is applied to scan electrode SCi+1.

In the first SF of subsequent j+1 field, a non-initializing waveform is applied to all scan electrodes 22.

In the first SF of subsequent j+2 field, a forced initializing waveform is applied to scan electrode SCi+1, and a non-initializing waveform is applied to scan electrode SCi.

In the first SF of j+3 field, a non-initializing waveform is applied to all discharge cells 22.

In this manner, the operation in one scan electrode group in one field group is completed. In the other scan electrode groups, the operation the same as the above is performed. Also thereafter, the operation the same as the above is repeated in each field group. In the structure of FIG. 9, j field, j+2 field, and j+4 field, for example, are specified-cell initializing fields, and j+1 field, j+3 field, and j+5 field, for example, are non-initializing fields.

In the example of FIG. 9, the frequency of forced initializing operations performed in each discharge cell can be reduced to one-fourth of that in the structure where the forced initializing operation is performed in all the discharge cells in each field.

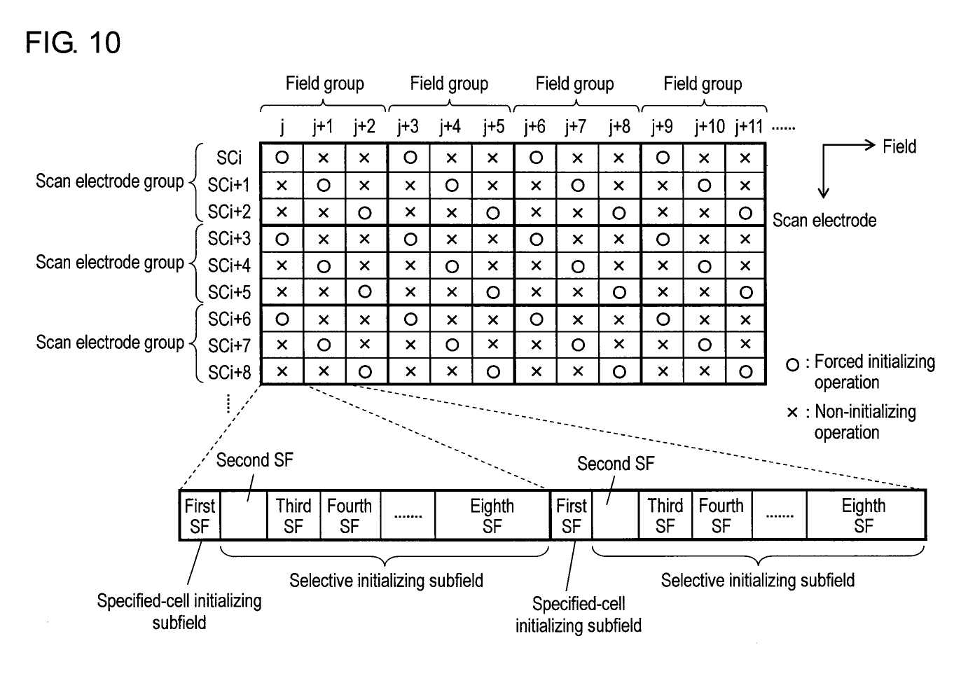

FIG. 10 is a schematic chart showing an example of the pattern of forced initializing waveforms and non-initializing waveforms generated when the frequency of forced initializing operations performed in each discharge cell is once every three fields in accordance with the first exemplary embodiment of the present invention.

In the example shown in FIG. 10, three temporally consecutive fields form one field group, and three positionally consecutive scan electrodes 22 form one scan electrode group. In the example of FIG. 10, different from the example of FIG. 8, each field group is formed of specified-cell initializing fields only.

Hereinafter, a description is provided, using scan electrode SCi through scan electrode SCi+2 forming one scan electrode group and j field through j+2 field forming one field group, as an example.

First, in the first SF of j field, a forced initializing waveform is applied to scan electrode SCi, and a non-initializing waveform is applied to scan electrode SCi+1 and scan electrode SCi+2.

In the first SF of subsequent j+1 field, a forced initializing waveform is applied to scan electrode SCi+1, and a non-initializing waveform is applied to scan electrode SCi and scan electrode SCi+2.

In the first SF of subsequent j+2 field, a forced initializing waveform is applied to scan electrode SCi+2, and a non-initializing waveform is applied to scan electrode SCi and scan electrode SCi+1.

In this manner, the operation in one scan electrode group in one field group is completed. In the other scan electrode groups, the operation the same as the above is performed. Also thereafter, the operation the same as the above is repeated in each field group. In the structure of FIG. 10, all the fields are specified-cell initializing fields.

In the example of FIG. 10, the frequency of forced initializing operations performed in each discharge cell can be reduced to one-third of that in the structure where the forced initializing operation is performed in all the discharge cells in each field.

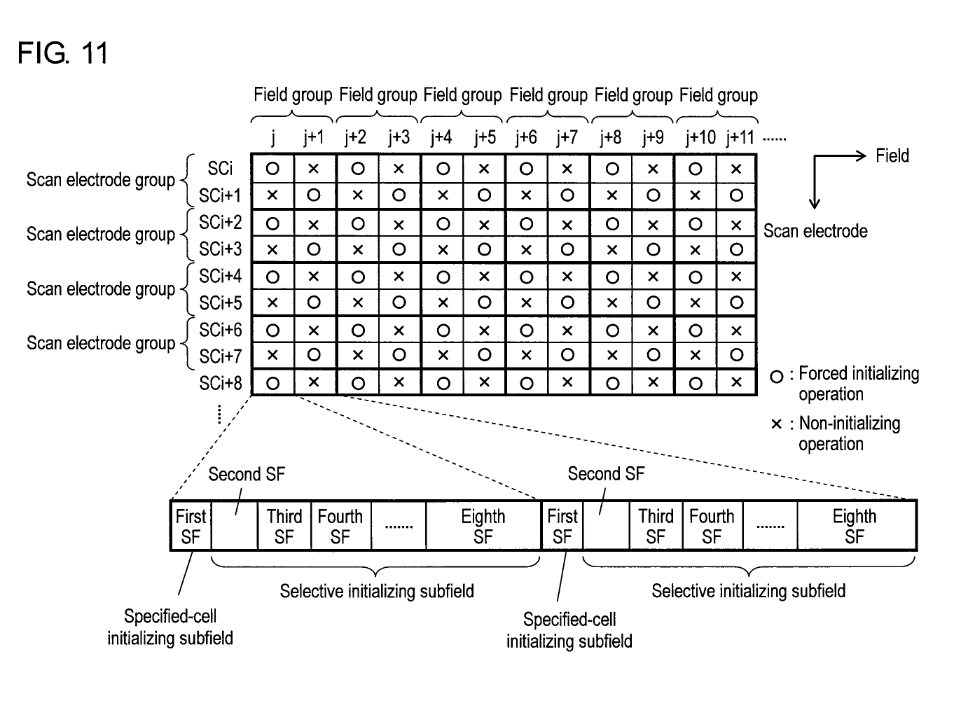

FIG. 11 is a schematic chart showing an example of the pattern of forced initializing waveforms and non-initializing waveforms generated when the frequency of forced initializing operations performed in each discharge cell is once every two fields in accordance with the first exemplary embodiment of the present invention.

In the example shown in FIG. 11, two temporally consecutive fields form one field group, and two positionally consecutive scan electrodes 22 form one scan electrode group. In the example of FIG. 11, similar to the example of FIG. 10, each field group is formed of specified-cell initializing fields only.

Hereinafter, a description is provided, using scan electrode SCi and scan electrode SCi+1 forming one scan electrode group and j field and j+1 field forming one field group, as an example.

First, in the first SF of j field, a forced initializing waveform is applied to scan electrode SCi, and a non-initializing waveform is applied to scan electrode SCi+1.

In the first SF of subsequent j+1 field, a forced initializing waveform is applied to scan electrode SCi+1, and a non-initializing waveform is applied to scan electrode SCi.

In this manner, the operation in one scan electrode group in one field group is completed. In the other scan electrode groups, the operation the same as the above is performed. Also thereafter, the operation the same as the above is repeated in each field group. In the structure of FIG. 11, all the fields are specified-cell initializing fields. In the example of FIG. 11, the frequency of forced initializing operations performed in each discharge cell can be reduced to a half of that in the structure where the forced initializing operation is performed in all the discharge cells in each field.

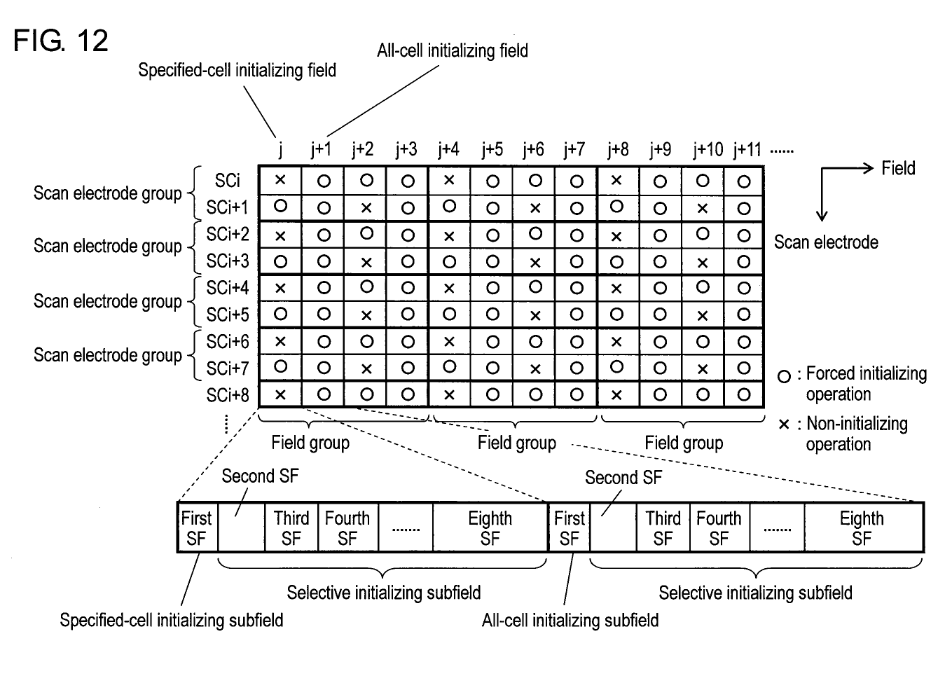

FIG. 12 is a schematic chart showing an example of the pattern of forced initializing waveforms and non-initializing waveforms generated when the frequency of forced initializing operations performed in each discharge cell is three times every four fields in accordance with the first exemplary embodiment of the present invention.

In the example shown in FIG. 12, four temporally consecutive fields form one field group, and two positionally consecutive scan electrodes 22 form one scan electrode group. In the example of FIG. 12, different from the examples of FIG. 8, FIG. 9, FIG. 10, and FIG. 11, each field group is formed of two types of fields, i.e. a specified-cell initializing field and an all-cell initializing field.

Hereinafter, a description is provided, using scan electrode SCi and scan electrode SCi+1 forming one scan electrode group and j field through j+3 field forming one field group, as an example.

First, in the first SF of j field, a forced initializing waveform is applied to scan electrode SCi+1, and a non-initializing waveform is applied to scan electrode SCi.

In the first SF of subsequent j+1 field, a forced initializing waveform is applied to all scan electrodes 22.

In the first SF of subsequent j+2 field, a forced initializing waveform is applied to scan electrode SCi, and a non-initializing waveform is applied to scan electrode SCi+1.

In the first SF of subsequent j+3 field, a forced initializing waveform is applied to all scan electrodes 22.

In this manner, the operation in one scan electrode group in one field group is completed. In the other scan electrode groups, the operation the same as the above is performed. Also thereafter, the operation the same as the above is repeated in each field group. In the structure of FIG. 12, j field, j+2 field, and j+4 field, for example, are specified-cell initializing fields, and j+1 field, j+3 field, and j+5 field, for example, are all-cell initializing fields.

In the example of FIG. 12, the frequency of forced initializing operations performed in each discharge cell can be reduced to three-quarters of that in the structure where the forced initializing operation is performed in all the discharge cells in each field.

When the forced initializing operation is performed once every field, all the fields are forced initializing fields. Thus, the description is omitted.

In an image at a high APL, the rate of black regions on the image display surface of panel 10 is relatively low. Thus, the influence of the brightness of the luminance of black level on the image display quality is relatively small. Therefore, even an increase in the frequency of forced initializing waveforms generated exerts substantially no influence on the image display quality.

As described above, in this exemplary embodiment, the frequency of forced initializing waveforms generated is changed according to the magnitude of APL detected in APL detecting circuit 49 in the following manner. In the display of an image at a low APL, the time intervals at which forced initializing waveforms are applied to scan electrodes 22 are increased. In the display of an image at a high APL, the time intervals at which forced initializing waveforms are applied to scan electrodes 22 are reduced. With this operation, in the display of an image (at a low APL) of which display quality is effectively improved by reducing luminance of black level, the frequency of initializing discharges caused by forced initializing waveforms is reduced. Thereby, the luminance of black level of the display image can be reduced so as to enhance the contrast of the display image. In the display of an image (at a high APL) where the address discharge relatively frequently occurs, the frequency of initializing discharges caused by forced initializing waveforms is increased. Thereby, the address discharge can be caused stably.

In the present invention, the subfields forming a field are not limited to the above four types of subfields, i.e. a specified-cell initializing subfield, a non-initializing subfield, an all-cell initializing subfield, and a selective initializing subfield. Further, the fields forming a field group are not limited to the above three types of fields, i.e. a specified-cell initializing field, a non-initializing field, and an all-cell initializing field. A subfield other than the above four types may be set so as to form a field. A field other than the above three types may be set so as to form a field group.

The patterns of forced initializing waveforms and non-initializing waveforms generated in the specified-cell initializing subfield in this exemplary embodiment only show examples, and the present invention is not limited to these structures. Any structure other than shown in this exemplary embodiment may be used as long as the structure can change the frequency of forced initializing waveforms to be generated.

### Second Exemplary Embodiment

As described above, the luminance of black level of a display image is changed by switching the frequency of forced initializing operations performed in each discharge cell.

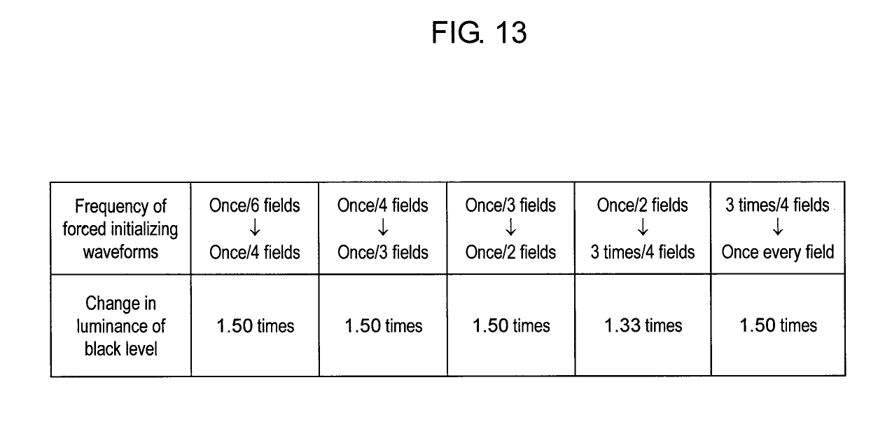

FIG. 13 is a chart showing changes in luminance of black level (relative values) when the frequency of forced initializing operations performed in each discharge cell is changed.

The result shown in FIG. 13 is obtained in the experiments conducted by the inventor. The luminance of black level when forced initializing operations are performed in each discharge cell once every four fields is 1.50 times as bright as the luminance of black level when forced initializing operations are performed once every six fields. The luminance of black level when forced initializing operations are performed in each discharge cell once every three fields is 1.50 times as bright as the luminance of black level when forced initializing operations are performed once every four fields. The luminance of black level when forced initializing operations are performed in each discharge cell once every two fields is 1.50 times as bright as the luminance of black level when forced initializing operations are performed once every three fields. The luminance of black level when forced initializing operations are performed in each discharge cell three times every four fields is 1.33 times as bright as the luminance of black level when forced initializing operations are performed once every two fields. The luminance of black level when forced initializing operations are performed in each discharge cell once every field is 1.50 times as bright as the luminance of black level when forced initializing operations are performed three times every four fields.

In this manner, when the frequency of forced initializing operations is changed, the luminance of black level changes. Then, in this exemplary embodiment, a description is provided for a structure of reducing the change in luminance of black level when the frequency of forced initializing operations is changed so that the change in luminance of black level is unlikely to be recognized by the user.

In this exemplary embodiment, when the brightness of a display image changes and thus the APL changes from a numerical value range to another numerical value range, first, the maximum voltage of the forced initializing waveform is changed. Next, the combination of fields forming a field group is changed. In this manner, the intervals at which forced initializing waveforms are generated are changed.

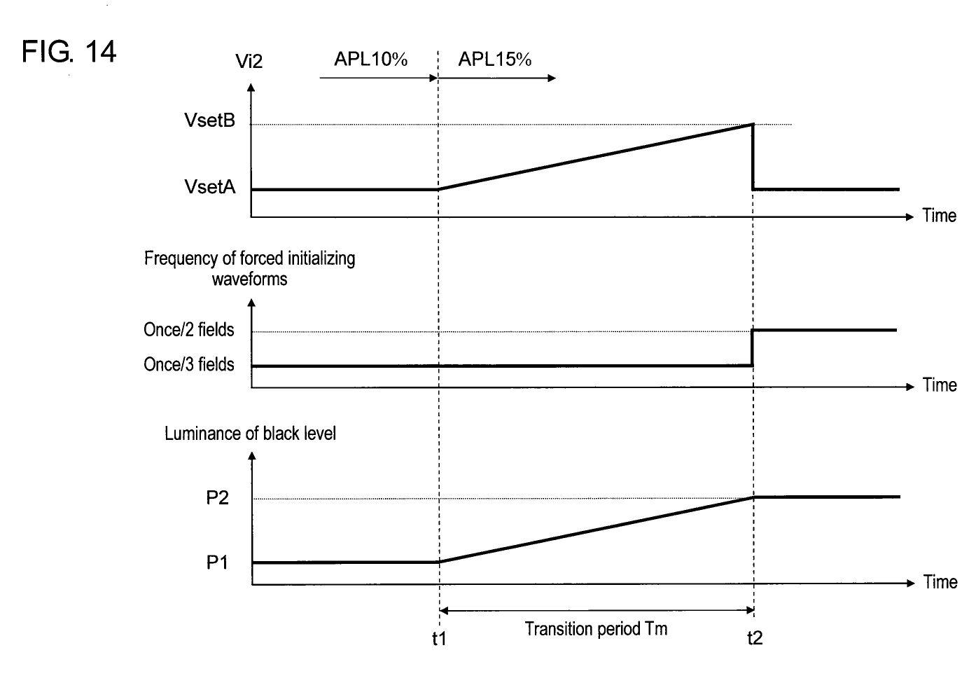

FIG. 14 is a schematic chart showing an example of the operation when the intervals at which forced initializing waveforms are generated are changed in the second exemplary embodiment of the present invention. In each chart in FIG. 14, the horizontal axis shows time. The top chart in FIG. 14 shows a temporal change in the maximum voltage of the forced initializing waveform. The vertical axis shows maximum voltage Vi2 of the forced initializing waveform. The middle chart in FIG. 14 shows a temporal change in the frequency of forced initializing waveforms generated. The vertical axis shows the frequency of forced initializing waveforms generated. The bottom chart in FIG. 14 shows a temporal change in luminance of black level in a display image. The vertical axis shows luminance of black level.

As an example of this exemplary embodiment, FIG. 14 shows an operation when APL changes from 10% to 15% at time t1.

For example, according to the rule shown in FIG. 7, the frequency of forced initializing operations performed in each discharge cell is once every three fields at an APL of 10%. At an APL of 15%, the frequency of forced initializing operations performed in each discharge cell is once every two fields. Therefore, according to the experimental results of FIG. 13, when the frequency of forced initializing operations changes from once every three fields to once every two fields, the luminance of black level increases to 1.50 times. Hereinafter, the luminance of black level before the change is denoted as “luminance of black level P1”, and the luminance of black level after the change is denoted as “luminance of black level P2”. In the example of FIG. 14, luminance of black level P2 is 1.50 times of luminance of black level P1.

In this exemplary embodiment, instead of switching the frequency of forced initializing operations at time t1 when the APL changes from 10% to 15%, predetermined transition period Tm (e.g. approximately one second) starting at time t1 is set. In transition period Tm, maximum voltage Vi2 of the forced initializing waveform is gradually raised from voltage VsetA as a reference voltage to voltage VsetB as a predetermined voltage. At time t2 when transition period Tm is completed, the combination of fields forming a field group is changed so as to switch the frequency of forced initializing operations. At the same time, maximum voltage Vi2 of the forced initializing waveform is returned from voltage VsetB to voltage VsetA. Hereinafter, the series of operations from time t1 to time t2 is also denoted as “transition operation”.

At this time, voltage VsetB is set such that the luminance of black level is not changed at time t2 when the frequency of forced initializing operations is switched and maximum voltage Vi2 of the forced initializing waveform is changed at the same time.

That is, voltage VsetB is set so as to satisfy the following condition: the luminance of black level when the frequency of forced initializing operations performed in each discharge cell is changed (to a frequency of once every two fields in the example of FIG. 14) with maximum voltage Vi2 of the forced initializing waveform kept at voltage VsetA is equal to the luminance of black level when maximum voltage Vi2 of the forced initializing waveform is changed to voltage VsetB with the frequency of forced initializing operations performed in each discharge cell kept unchanged (at a frequency of once every three fields in the example of FIG. 14).

In the example of FIG. 14, luminance of black level P2 is 1.50 times of luminance of black level P1. Thus, voltage VsetB is set such that the luminance of black level is increased to 1.50 times when maximum voltage Vi2 is changed from voltage VsetA to voltage VsetB with the frequency of forced initializing operations kept at a frequency of once every three fields.

With this setting, the luminance of black level can be gradually changed throughout transition period Tm from luminance of black level P1 to luminance of black level P2, and the frequency of forced initializing operations can be switched at time t2 without a change in luminance of black level caused. Therefore, compared with the case where luminance of black level is sharply changed from luminance P1 to luminance P2 by switching the frequency of forced initializing operations at time t1, the change in luminance of black level is unlikely to be recognized by the user.

Though not shown, in scan electrode driving circuit 43, a voltage rise can be continued in the period during which input terminal IN1 of Miller integrating circuit 53 is set to “Hi”. Therefore, by controlling the length of the period during which input terminal IN1 is at “Hi”, the magnitude of maximum voltage Vi2 of the forced initializing waveform can be controlled.

As described above, in this exemplary embodiment, the above structure reduces the change in luminance of black level caused when the frequency of forced initializing operations is switched so that the change in luminance of black level is unlikely to be recognized. Thereby, the image display quality can be enhanced.

Preferably, transition period Tm is set to a length at which the change in luminance of black level is unlikely to be recognized by the user. In this exemplary embodiment, the length of transition period Tm is set to approximately one second. However, the present invention is not limited to this length. The length of transition period Tm may be set optimally for the characteristics of the panel, the specifications of the plasma display device, or the like. The length of transition period Tm may be kept constant, or may be changed according to the amount of change in maximum voltage Vi2 of the forced initializing waveform. For example, transition period Tm1 when the luminance of black level is increased to 1.33 times may be set equal in length to transition period Tm2 when the luminance of black level is increased to 1.50 times. Alternatively, transition period Tm1 may be set shorter than transition period Tm2.

When the APL sharply and considerably changes, the change in luminance of black level is unlikely to be recognized. Thus, only when the APL gradually changes, i.e. the APL changes from one numerical value range to another numerical value range adjacent to the one numerical value range, the above transition operation is performed. When the APL sharply changes from one numerical value range to still another numerical value range, skipping over the numerical value range adjacent to the one numerical value range (e.g. the APL sharply changes from 10% to 70%), the frequency of forced initializing operations may be switched without the above transition operation.

When the APL changes to still another numerical value range during transition period Tm, either continuation or discontinuation of the transition operation may be selected optimally for the amount of change.

In this exemplary embodiment, a description is provided for a structure where the luminance of black level changes in an increasing direction. When the luminance of black level changes in a decreasing direction, maximum voltage Vi2 is gradually decreased in the transition operation.

The following description is provided for time t2: “the frequency of forced initializing operations is switched and maximum voltage Vi2 of the forced initializing waveform is changed at the same time.” The expression “at the same time” does not mean exactly “at the same time”, and means substantially “at the same time”. Variations are allowed within the range where the display image is not affected.

Further, the following description is provided for voltage VsetB: “set such that the luminance of black level is not changed at time t2 when the frequency of forced initializing operations is switched and maximum voltage Vi2 of the forced initializing waveform is changed at the same time.” However, this expression does not exactly mean “is not changed”, and variations are allowed within the range where the display image is not affected.

### Third Exemplary Embodiment

Typically, in plasma display device 1, the discharge characteristics of the discharge cells change according to the length of the service period of panel 10. For example, the breakdown voltage of the discharge cells in panel 10 after a long service period is higher than that in panel 10 after a short service period.

Therefore, in order to reduce the luminance of black level in the display image, enhance the contrast of the display image, and cause a stable address discharge even after a long service period of panel 10, it is preferable to change the frequency of forced initializing waveforms according to the length of the service period of plasma display device 1. Then, this exemplary embodiment shows a structure of changing the frequency of forced initializing waveforms to be generated according to the length of the service period of plasma display device 1.

The length of the service period of plasma display device 1 can be measured with an operating time accumulating circuit (not shown), for example, which is installed in the plasma display device and has a timer for operating only when plasma display device 1 operates, and a memory for cumulatively adding the measured time and storing the result.

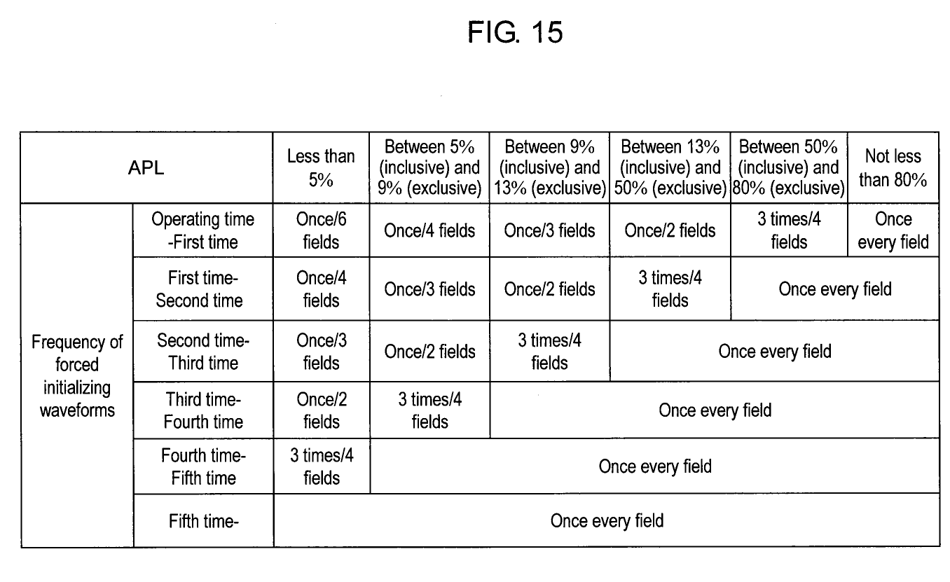

FIG. 15 is a chart showing an example of cumulative values of the operating time of plasma display device 1 and frequencies of forced initializing waveforms generated in accordance with a third exemplary embodiment of the present invention.

In this exemplary embodiment, as shown in FIG. 15, for example, until the cumulative value of the operating time measured in the operating time accumulating circuit reaches a predetermined “first time”, the following operations are performed. That is, in the display of an image at an APL less than 5%, the forced initializing waveforms are generated with a frequency of once every six fields. In the display of an image at an APL equal to or more than 5% and less than 9%, the forced initializing waveforms are generated once every four fields. In the display of an image at an APL equal to or more than 9% and less than 13%, the forced initializing waveforms are generated once every three fields. In the display of an image at an APL equal to or more than 13% and less than 50%, the forced initializing waveforms are generated once every two fields. In the display of an image at an APL equal to or more than 50% and less than 80%, the forced initializing waveforms are generated three times every four fields. In the display of an image at an APL equal to or more than 80%, the forced initializing waveforms are generated once every field.

After the cumulative value of the operating time measured in the operating time accumulating circuit has reached the “first time” and until it reaches a predetermined “second time”, the following operations are performed. That is, in the display of an image at an APL less than 5%, the forced initializing waveforms are generated with a frequency of once every four fields. In the display of an image at an APL equal to or more than 5% and less than 9%, the forced initializing waveforms are generated once every three fields. In the display of an image at an APL equal to or more than 9% and less than 13%, the forced initializing waveforms are generated once every two fields. In the display of an image at an APL equal to or more than 13% and less than 50%, the forced initializing waveforms are generated three times every four fields. In the display of an image at an APL equal to or more than 50%, the forced initializing waveforms are generated once every field.

After the cumulative value of the operating time measured in the operating time accumulating circuit has reached the “second time” and until it reaches a predetermined “third time”, the following operations are performed. That is, in the display of an image at an APL less than 5%, the forced initializing waveforms are generated with a frequency of once every three fields. In the display of an image at an APL equal to or more than 5% and less than 9%, the forced initializing waveforms are generated once every two fields. In the display of an image at an APL equal to or more than 9% and less than 13%, the forced initializing waveforms are generated three times every four fields. In the display of an image at an APL equal to or more than 13%, the forced initializing waveforms are generated once every field.

After the cumulative value of the operating time measured in the operating time accumulating circuit has reached the “third time” and until it reaches a predetermined “fourth time”, the following operations are performed. That is, in the display of an image at an APL less than 5%, the forced initializing waveforms are generated with a frequency of once every two fields. In the display of an image at an APL equal to or more than 5% and less than 9%, the forced initializing waveforms are generated three times every four fields. In the display of an image at an APL equal to or more than 9%, the forced initializing waveforms are generated once every field.

After the cumulative value of the operating time measured in the operating time accumulating circuit has reached the “fourth time” and until it reaches a predetermined “fifth time”, the following operations are performed. That is, in the display of an image at an APL less than 5%, the forced initializing waveforms are generated with a frequency of three times every four fields. In the display of an image at an APL equal to or more than 5%, the forced initializing waveforms are generated once every field.

After the cumulative value of the operating time measured in the operating time accumulating circuit has reached the “fifth time”, the forced initializing waveforms are always generated with a frequency of once every field. For example, in this exemplary embodiment, the “first time” is 200 hours, the “second time” is 500 hours, the “third time” is 1000, hours, the “fourth time” is 2000 hours, and the “fifth time” is 4000 hours. The present invention is not limited to these numerical values. Preferably, numerical values are set optimally for the characteristics of the panel, the specifications of the plasma display device, or the like.

As described above, in this exemplary embodiment, the frequency of forced initializing waveforms to be generated is changed according to the length of the service period of plasma display device 1. This structure can reduce the luminance of black level in the display image so as to enhance the contrast of the display image, while causing a stable address discharge even after a long service period of panel 10.

In this exemplary embodiment, hysteresis characteristics may be taken into account in detection of APL. For this purpose, the threshold value used in APL detecting circuit 49 when the APL increases is set more than the threshold value used when the APL decreases.

The timing chart of FIG. 6 only shows an example in the exemplary embodiments of the present invention, and the present invention is not limited to these timing charts.

The exemplary embodiments of the present invention can also be applied when a panel is driven by two-phase driving. The two-phase driving is a driving method in which scan electrode SC1 through scan electrode SCn are divided into a first scan electrode group and a second scan electrode group. Further, each address period is formed of two address periods, i.e. a first address period where a scan pulse is applied to each scan electrode belonging to the first scan electrode group, and a second address period where the scan pulse is applied to each scan electrode belonging to the second scan electrode group.

The exemplary embodiments of the present invention are also effective in a panel having an electrode structure where a scan electrode is adjacent a scan electrode and a sustain electrode is adjacent to a sustain electrode. In this electrode structure, the electrodes are arranged on the front plate in the following order: a scan electrode, a scan electrode, a sustain electrode, a sustain electrode, a scan electrode, a scan electrode, or the like.

The specific numerical values in the exemplary embodiments, e.g. the gradients of up-ramp voltage L1, down-ramp voltage L2, and erasing ramp voltage L3, are set according to the characteristics of a 50-inch diagonal panel having 1080 display electrode pairs, and only show examples in the exemplary embodiments. The present invention is not limited to these numerical values. Preferably, numerical values are set optimally for the characteristics of the panel, the specifications of the plasma display device, or the like. For each of these numerical values, variations are allowed within the range where the above advantages can be obtained.

### INDUSTRIAL APPLICABILITY

The present invention reduces the luminance of black level of the display image so as to enhance the contrast in the display of an image at a low average picture level, and causes an address discharge stably in the display of an image at a high average picture level. Thereby, the image display quality can be enhanced. Thus, the present invention is useful as a driving method for a panel, and a plasma display device.

### REFERENCE SIGNS LIST

1 Plasma display device
10 Panel (Plasma display panel)
21 Front plate
22 Scan electrode
23 Sustain electrode
24 Display electrode pair
25, 33 Dielectric layer
26 Protective layer
31 Rear plate
32 Data electrode
34 Barrier rib
35 Phosphor layer
41 Image signal processing circuit
42 Data electrode driving circuit
43 Scan electrode driving circuit
44 Sustain electrode driving circuit
45 Timing generating circuit
49 APL detecting circuit
50 Sustain pulse generating circuit
51 Initializing waveform generating circuit
52 Scan pulse generating circuit
53, 54, 55 Miller integrating circuit
Q1, Q2, Q3, Q4, Q5, Q6, QH1 through QHn, QL1 through QLn, Switching element
C1, C2, C3, C31 Capacitor
Di31 Diode
R1, R2, R3 Resistor
L1 Up-ramp voltage
L2, L4 Down-ramp voltage
L3 Erasing ramp voltage

1. A driving method for a plasma display panel,
the plasma display panel having a plurality of discharge cells, the discharge cells having display electrode pairs, each of the display electrode pairs being formed of a scan electrode and a sustain electrode,
the plasma display panel displaying gradations such that a plurality of subfields is set in one field and each of the subfields has an initializing period, an address period, and a sustain period,
the driving method comprising:
applying one of a forced initializing waveform, a selective initializing waveform, and a non-initializing waveform to the scan electrodes in the initializing period, the forced initializing waveform causing an initializing discharge in the discharge cells irrespective of an operation in an immediately preceding subfield, the selective initializing waveform causing an initializing discharge only in the discharge cells having undergone a sustain discharge in the sustain period of the immediately preceding subfield, the non-initializing waveform causing no initializing discharge in the discharge cells;
setting a specified-cell initializing subfield and a selective initializing subfield, the specified-cell initializing subfield being where the forced initializing waveform is applied to predetermined scan electrodes and the non-initializing waveform is applied to other scan electrodes in the initializing period, and the selective initializing subfield being where the selective initializing waveform is applied to all the scan electrodes in the initializing period;
setting a specified-cell initializing field having the specified-cell initializing subfield and the plurality of selective initializing subfields; and
changing frequency of the forced initializing waveforms to be generated, according to a magnitude of an average picture level of an input image signal, such that the frequency of the forced initializing waveforms to be applied to the scan electrodes is reduced as the average picture level decreases.

2. The driving method for the plasma display panel of claim 1, comprising:
setting a non-initializing subfield where the non-initializing waveform is applied to all the scan electrodes in the initializing period, and an all-cell initializing subfield where the forced initializing waveform is applied to all the scan electrodes in the initializing period;
setting at least three types of fields, the three types of fields including:
the specified-cell initializing field;
a non-initializing field having the non-initializing subfield and the plurality of selective initializing subfields; and
an all-cell initializing field having the all-cell initializing subfield and the plurality of selective initializing subfields;
forming one field group of the plurality of temporally consecutive fields by using any one or two of the three types of fields; and
changing combination of the fields forming the field group, according to the magnitude of the average picture level, such that the frequency of the forced initializing waveforms to be applied to the scan electrodes is reduced as the average picture level decreases.

3. The driving method for the plasma display panel of claim 1, wherein the forced initializing waveforms are generated such that the number of scan electrodes to be applied with the forced initializing waveforms is equal in the respective specified-cell initializing subfields in the field group formed of the plurality of specified-cell initializing fields.

4. The driving method for the plasma display panel of claim 2, wherein
the average picture level is divided into a plurality of numerical value ranges and the combination of the fields forming the field group is set for each of the numerical value ranges, and
when the average picture level changes from one of the numerical value ranges to another one of the numerical value ranges, first, a maximum voltage of the forced initializing waveform is changed, and next, the combination of the fields forming the field group is changed.

5. The driving method for the plasma display panel of claim 4, wherein
when the average picture level changes from one of the numerical value ranges to another one of the numerical value ranges adjacent to the one of the numerical value ranges, the maximum voltage of the forced initializing waveform is gradually changed throughout a predetermined transition period from a reference voltage to a predetermined voltage, and after the maximum voltage has reached the predetermined voltage, the combination of the fields forming the field group is changed and the maximum voltage is changed from the predetermined voltage to the reference voltage at a same time, and
when the average picture level changes from one of the numerical value ranges to still another one of the numerical value ranges, skipping over the another one of the numerical value ranges adjacent to the one of the numerical value ranges, the combination of the fields forming the field group is changed without the maximum voltage changed.

6. The driving method for the plasma display panel of claim 4, comprising:
measuring a cumulative value of operating time of a plasma display device including the plasma display panel; and
changing the frequency of the forced initializing waveforms to be generated, according to the cumulative value.

7. A plasma display device comprising:
a plasma display panel,
the plasma display panel being driven by a subfield method for gradation display in which a plurality of subfields are set in one field, and each of the subfields has an initializing period, an address period, and a sustain period,
in the subfield method, a specified-cell initializing subfield and a selective initializing subfield being set as the subfields; a specified-cell initializing field having the specified-cell initializing subfield and the plurality of selective initializing subfields being set,
the plasma display panel having a plurality of discharge cells, the discharge cells having display electrode pairs, each of the display electrode pairs being formed of a scan electrode and a sustain electrode;
a scan electrode driving circuit for
in the initializing period, generating and applying, to the scan electrodes, any one of a forced initializing waveform, a selective initializing waveform, and a non-initializing waveform, the forced initializing waveform causing an initializing discharge in the discharge cells irrespective of an operation in an immediately preceding subfield, the selective initializing waveform causing an initializing discharge only in the discharge cells having undergone a sustain discharge in the sustain period of the immediately preceding subfield, and the non-initializing waveform causing no initializing discharge in the discharge cells,
in the initializing period of the specified-cell initializing subfield, applying the forced initializing waveform to predetermined scan electrodes and the non-initializing waveform to other scan electrodes, and
in the initializing period of the selective initializing subfield, applying the selective initializing waveform to all the scan electrodes; and
an APL detecting circuit for detecting average picture level of an input image signal,
wherein the scan electrode driving circuit changes frequency of the forced initializing waveforms to be generated, according to a magnitude of the average picture level, such that the frequency of the forced initializing waveforms to be applied to the scan electrodes is reduced as the average picture level detected in the APL detecting circuit decreases.

8. The plasma display device of claim 7, wherein
a non-initializing subfield and an all-cell initializing subfield are further set,
the scan electrode driving circuit generates and applies the non-initializing waveform to all the scan electrodes in the initializing period of the non-initializing subfield, and generates and applies the forced initializing waveform to all the scan electrodes in the initializing period of the all-cell initializing subfield,
at least three types of fields are set, the three types of fields including:
the specified-cell initializing field;
a non-initializing field having the non-initializing subfield and the plurality of selective initializing subfields; and
an all-cell initializing field having the all-cell initializing subfield and the plurality of selective initializing subfields,
using any one or two of the three types of fields, one field group is formed of the plurality of temporally consecutive fields, and
a structure of the field group is switched, according to the average picture level, such that the frequency of the forced initializing waveforms to be applied to the scan electrodes is reduced as the average picture level decreases.

9. The plasma display device of claim 7, wherein
the scan electrode driving circuit has a ramp voltage generating circuit for generating a rising ramp voltage, and
the scan electrode driving circuit generates a voltage where a predetermined voltage is superimposed on the ramp voltage output from the ramp voltage generating circuit, as the forced initializing waveform, and generates the ramp voltage where the predetermined voltage is not superimposed, as the non-initializing waveform.

10. The driving method for the plasma display panel of claim 2, wherein the forced initializing waveforms are generated such that the number of scan electrodes to be applied with the forced initializing waveforms is equal in the respective specified-cell initializing subfields in the field group formed of the plurality of specified-cell initializing fields.

11. The plasma display device of claim 8, wherein
the scan electrode driving circuit has a ramp voltage generating circuit for generating a rising ramp voltage, and
the scan electrode driving circuit generates a voltage where a predetermined voltage is superimposed on the ramp voltage output from the ramp voltage generating circuit, as the forced initializing waveform, and generates the ramp voltage where the predetermined voltage is not superimposed, as the non-initializing waveform.
